(19) United States
(12) Patent Application Publication
(10) Pub. No.: US 2014/0188707 A1
(43) Pub. Date: Jul. 3, 2014

(54) Methods and Systems for Implementing and Using an Electronic Network-Based Voluntary Contribution System

(71) Applicant: Kachingle, Inc., (US)

(72) Inventor: Cynthia Typaldos, Mount Vernon, MO (US)

(73) Assignee: Kachingle, Inc., Palo Alto, CA (US)

(21) Appl. No.: 13/791,259

(22) Filed: Mar. 8, 2013

Related U.S. Application Data
(63) Continuation of application No. 12/249,871, filed on Oct. 10, 2008, now abandoned.
(60) Provisional application No. 60/998,268, filed on Oct. 10, 2007.

(51) Int. Cl. G06Q 20/10

(52) U.S. Cl. CPC G06Q 20/10
USPC 705/39

(57) ABSTRACT

The electronic network-based voluntary contribution system according to embodiments of the present invention implement a new business model for these sites that can coexist with, complement, or in some cases, replace advertising. The electronic network-based voluntary contribution system provides online content and service providers with a simple “hands-free” user-centric monetization service fueled by existing social networking services.

This application is a continuation of U.S. patent application Ser. No. 12/249,871 which claims priority to U.S. Provisional Application No. 60/998,269 filed on Oct. 10, 2007, which application is expressly incorporated by reference herein.

### FIELD OF THE INVENTIONS

The present inventions are directed to methods and systems for implementing and using an electronic network-based contribution system.

### BACKGROUND

Many online content and service creators, from individuals to startups to giant media corporations, are unable to sustain their businesses based on advertising revenue alone. Before the internet, publishers set the price of books, artists and photographers set the price of their work, newspapers set the price of their subscriptions, services such as software tools set the price of their products. Some content has traditionally been free but paid for through advertising—such as broadcast TV. But nearly all content and service pricing has been one or a combination of fixed price, subscription price, or free but subsidized through advertising.

After the internet, these business models have persisted but with some difficulty as the physical manifestation of content has in most cases disappeared. Electronic versions are treated as trivial and are essentially cost free to create, publish, and distribute. Additionally, the quantity of content and services has grown exponentially.

Because there is so much content and so many services available, subscription fees are difficult to implement as consumers are overwhelmed by the choices, the aggregate cost, and the inability to connect price with value delivered. Fixed price and subscription price business models have suffered more than advertising, partly because they require barriers to access, which removes them from the powerful internet-based viral mechanisms such as links, widgets, and social sharing. But even advertising has its limitations online as it can be intrusive, irrelevant, or insufficient to support costs.

### SUMMARY

The electronic network-based voluntary contribution system according to embodiments of the present invention implement a new business model for these sites that can coexist with, complement, or in some cases, replace advertising.

The electronic network-based voluntary contribution system provides online content and service providers with a simple “hands-free” user-centric monetization service fueled by existing social networking services.

Those that make the monetary contributions are called “Contributors”. Contributors are individual consumers. Those that receive the contributions are called “Recipients”. Recipients are the online content or service owners. The Recipients can be individuals, non-profits, or corporations and the Recipient Sites can be blogs, wikis, websites, music, videos, magazines, newspapers, online services, online publications, online content, social networks, social networking profiles, and any combination of these and other valued information and services, and anything else that Contributors find useful. One embodiment of the electronic network-based voluntary contribution system targets blog readers (as Contributors) and blogs and wilds (as Recipient Sites). In many cases, a Contributor will also be a Recipient (and vice versa).

These and other aspects and advantages of various embodiments of the present invention will be provided hereinafter.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 illustrates a table of contributor user registration information according to one embodiment of the electronic network-based voluntary contribution system;

FIG. 2 illustrates an initial information set from for a website registration in order for the website to be a supported recipient site according to one embodiment of the electronic network-based voluntary contribution system;

FIGS. 3, 4 and 5A-5I illustrate different parts of the registration process, which follow the information provided from FIG. 2, in order for the website to be a supported recipient site according to one embodiment of the electronic network-based voluntary contribution system;

FIGS. 6 and 7 illustrate inactive and active Medallion functionality according to one embodiment of the electronic network-based voluntary contribution system;

FIG. 8 illustrates a functional overview of a tracking mechanism according to one embodiment of the electronic network-based voluntary contribution system;

FIG. 9 illustrates point distribution notification to a contributor according to one embodiment of the electronic network-based voluntary contribution system.

FIG. 10 illustrates point distribution notification to a recipient of a specific supported recipient site according to one embodiment of the electronic network-based voluntary contribution system.

FIG. 11 illustrates a widgetized point display that shows a contributors points that is adapted for display on a remote site as desired by the contributor, such as social networking site, according to one embodiment of the electronic network-based voluntary contribution system;

FIG. 12 illustrates a table of contributor data accessible to a contributor at the electronic network-based voluntary contribution system server according to one embodiment of the electronic network-based voluntary contribution system;

FIG. 13 illustrates a widgetized point display that shows a display of points that is adapted for display on a recipient site or other internet location, and which outlines activity related to that recipient site, according to one embodiment of the electronic network-based voluntary contribution system;

FIGS. 14 and 15 illustrate Recipient and Contributor widgets, respectively, interlinked with an attention tracking algorithm, according to one embodiment of the electronic network-based voluntary contribution system;

FIGS. 16A1-A2 illustrates an overview of the payment process functionality associated with one embodiment of the electronic network-based voluntary contribution system and in particular collecting contributions;

FIGS. 16B1-B2 illustrates an overview of the payment process functionality associated with one embodiment of the electronic network-based voluntary contribution system and in particular distributing contributions.

FIG. 17 illustrates an electronic badge available to particular users that meet certain predetermined requirements according to one embodiment of the electronic network-based voluntary contribution system.

FIG. 18 illustrates an architecture overview according to one embodiment of the electronic network-based voluntary contribution system.

### DETAILED DESCRIPTION OF THE PREFERRED EMBODIMENTS

The electronic network-based voluntary contribution system (hereafter “ENBVCS”) provides an internet-wide monetization service and various other aspects and advantages as will become apparent herein. The ENBVCS builds upon existing proven and established internet tools (e.g. payment services, social networking, widgets) and adds unique aspects that tie together the need for content providers to receive monetary compensation and the powerful desire for content consumers to individualize themselves, achieve peer recognition, and be part of a larger community.

### TERMINOLOGY

As used herein, various terms will be used to include the following meanings as expressed, though there is usage is not intended to limit their usage as a result. Rather, these terms are used to give a context to the various embodiments described herein.

Contributor (a.k.a. “Online Content/Service Consumer”)

Online content or service consumer (online means internet-based) using the internet thru a computer, phone, or any other internet enabled device in order to access online content or service such as wikis, websites, blogs, music, videos, discussion boards, online publications, online content, social networks, social networking profiles, and any combination of these and other valued information and services, and so on. The Contributor can be an individual, an aggregation of individuals or an organization. This consumer has signed up for the ENBVCS service as a Contributor. Note that any user can be both a Contributor and a Recipient.

### Recipient & “Recipient Site”

A Recipient is the owner or manager of one or multiple “Recipient Sites”. “Recipient Sites” can be any individually identifiable online content or service The ENBVCS works not only for content sites (e.g. blogs, NYTimes, Wikipedia) but also for sites that are service oriented e.g. Facebook, Blogger itself the tool not the blogs, Digg, StumbleUpon, flickr. Thus, a contributor can contribute to the service (e.g. Blogger) because they like the tool and want to be associated with it, and also to content that resides on that service (e.g. a particular blog that is hosted on Blogger). As such, the embodiments of the present invention are applicable to websites, online content blogs, music, videos, discussion boards, online publications, social networks, social networking profiles, and any combination of these and other valued information and services, and so on. The Recipient can be an individual, an aggregation of individuals or an organization. An online content or service becomes a “Recipient Site” when the Recipient adds the ENBVCS Medallion to that content or service. This content or service provider has signed up for the ENBVCS service as a Recipient. Note that any user can be both a Recipient and a Contributor. These content or services can reside on any device, such as a mobile device, laptop, pda, desktop computer, or other device that is connected to the internet.

### Tracking

Tracking is the activity of monitoring the visits by an ENBVCS user to a Recipient Site. Tracking is implemented thru the installation of the Medallion Widget on a Recipient Site, which then communicates with the ENBVCS Server. In one embodiment, the user has the option to turn tracking on and off.

Medallion Widget (a.k.a. Medallion)

The software instantiation of the mechanism that is placed on a “Recipient Site” by the Recipient in order to include their site/service in the ENBVCS ecosystem. These Medallion Widgets track Contributors' usage of Recipient Sites and continuously, periodically, or at some interval report this information back to the ENBVCS server. The Medallion has multiple other functions including and not limited to displaying the Contributor's status information, enabling the Contributor to turn on/off the “Attention Tracking” system, allowing the Contributor to set each “Recipient Site” as one s/he wish to contribute to (or not), displaying marketing messages, links to additional ENBVCS-based information and so on.

### “Attention Tracking” Algorithm

Any algorithm based on the information supplied by the Medallion Widget (which is tracking the usage of “Recipient Sites” by Contributors). An example would be to count the first visit of each day to a particular “Recipient Site” as “1 Token”. Other algorithms can be used and are within the scope of the present invention. Other examples are number of page views, number of visits per timeframe, monetary value of each visit or group of visits, the social profiling attached to those visits (e.g. my friends), Recipient Site tags, type of business (e.g. for-profit vs. non-profit), category, date or time of day, language, etc.

### Tokens & Points

Tokens, also referred to as contribution units, are a measure of the value of a “Recipient Site” to a particular Contributor and are based on the usage by a Contributor (and modified by the “Attention Tracking” algorithm). Tokens aggregated are turned into Points, which can be a number, an amount of money, a gradation of color intensity, a vote, etc. Points are a proxy for value delivered to the Contributor.

### Contributing

Action of the Contributor visiting online content or services that are “Recipient Sites” while having the “attention tracking” mechanism turned on, thus instructing the Medallions to report this usage activity to the ENBVCS Server.

### Contributing/not Contributing to a Recipient Site

A Contributor (with tracking turned on) can preferably choose whether or not to include a Recipient Site in the list of sites that should receive an allocation of his/her Tokens/Points. The default can be either that all, or a subset, or no sites are set in the on state for Contributing. In one embodiment of the ENBVCS, the default is all Recipient Sites are initially set in the “off” state for Contributing. The Medallion includes a mechanism to switch each Recipient Site from one state (e.g. Contributing) to another state (e.g. Not Contributing). More states are possible such as “Undecided”. One such mechanism that is usable is a checkbox for the user interface, associated with a call to the server to deliver the information.

### “My Recipients Widget”

The information about the usage (reported in Points) of “Recipient Sites” by a particular Contributor. This information can be private (viewable only by the Contributor and residing on the ENBVCS server), or publicly viewable in a variety of formats (e.g. on the ENBVCS server indexed by Contributor or other criteria, in widgetized form for placement on sites such as blogs, social networking profiles, or any other display mechanism. by the Contributor). These displays are the tool that a Contributor uses to view and publicize his/her activity. These displays are a mechanism to give credit to Contributors on their own sites, data to compare and value “Recipient Sites”, and a mechanism to prove to both Contributors and Recipients that the proper number of Points have been allocated (without any fraud or skimming by The ENBVCS). The Contributor can modify the data in the “My Recipient Widget” in a variety of ways; for example for privacy reasons a Contributor may want to show some but not all of his/her Recipient Sites in the public view.

### “My Contributors Widget”

The information about the usage (reported in Points) of Contributors to a particular “Recipient Site”. This information is public (and can be customized to become private) and available in a variety of formats—on the ENBVCS website, in widgetized form for placement on sites such as blogs, social networking profiles, etc. by the Recipient. These displays are a mechanism to give credit to Contributors of a “Recipient Site”, data to compare and value “Recipient Sites”, and a mechanism to prove to both Contributors and Recipients that the proper number of Points have been allocated (without any fraud or skimming by the ENBVCS). The Recipient Site cannot modify the basic underlying Points data, but may have control over formatting, providing awards to top Contributors, and so on.

### Overview

The ENBVCS provides recognition for contributions by users in two ways—

1—the “My Recipients Widget” which the Contributor can place on his/her social networking profile, website, blog, etc. It can also reside on the ENBVCS server in widget or webpage form with a link that the user can include as they like (e.g. on their blog, in emails, etc.). This widget is the way the Contributor broadcasts to his/her existing peers and colleagues about “who I am”. While the name for this information includes the word “widget”, any mechanism that allows someone to find the information is possible (e.g. a link to a webpage on the ENBVCS website).

2—the “My Contributors Widget” which resides on the Recipient Site and provides recognition for Contributors in the ecosystem of that site. This widget is the way a user broadcasts to his/her colleagues on that site about “I am a supporter”. This widget is also the way a Recipient broadcasts to his/her visitors and contributors on that site about “who supports me”. While the name for this information includes the word “widget”, any mechanism that allows someone to find the information is possible (e.g. a link to a webpage on the ENBVCS website).

The mechanism the ENBVCS uses to allocate contributions is critical, as it must have very minimal mental and microtransaction costs. The ENBVCS implements a tracking system and on top of that imposes an “allocation algorithm” to assign fairly the contributions from consumers to Recipient Sites.

The following sets forth the process of implementing the ENBVCS. It is understood that the technological underpinnings of the present invention, from hardware, software and communications perspectives, are known, and one of ordinary skill in the art will be able to implement the various elements of the present invention based upon the following explanation. It will be apparent that the ENBVCS server will include hardware and software that provides overall control, though it is understood that this ENBVCS server can be implemented in a centralized server or a distributed network. Accordingly, this can be viewed as a computer system, whether implemented in a centralized server or a distributed network and can include any internet enabled devices, including mobile devices.

### User Registration

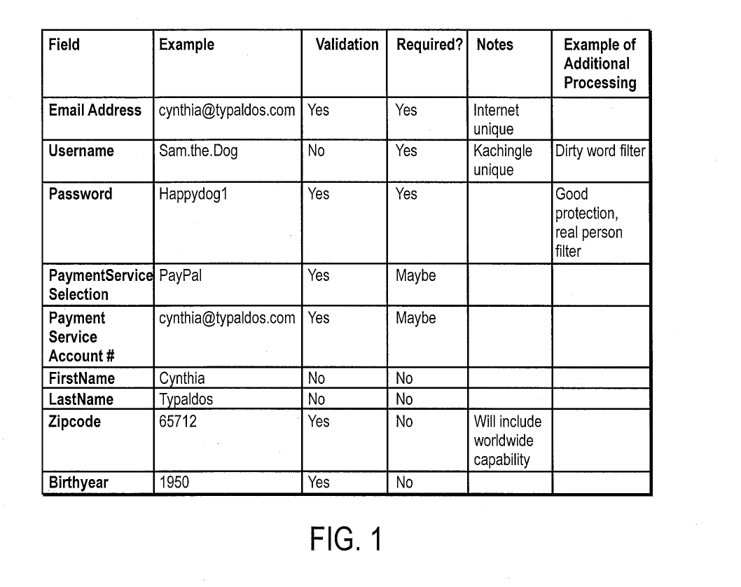

As shown in the table provided in FIG. 1, Users register by providing information to the ENBVSC server. While this set of information may change over time, the key required fields are similar to many web services (e.g. email address, username, password).

Additionally, the registration process also asks for a Payment Service Selection if the user chooses to be a Contributor (and Points have been set to be $) so also required is the Payment Service account number and other information required to make a connection to that Payment Service on behalf of the Contributor. This connection mechanism depends on the Payment Service selected. Note that the Payment Service Selection does not have to be made at the time of registration, it could be done later. This FIG. 1 is a table view of user registration details, according to one embodiment. This user can be a Contributor or a Recipient or both.

### Recipient Site Registration

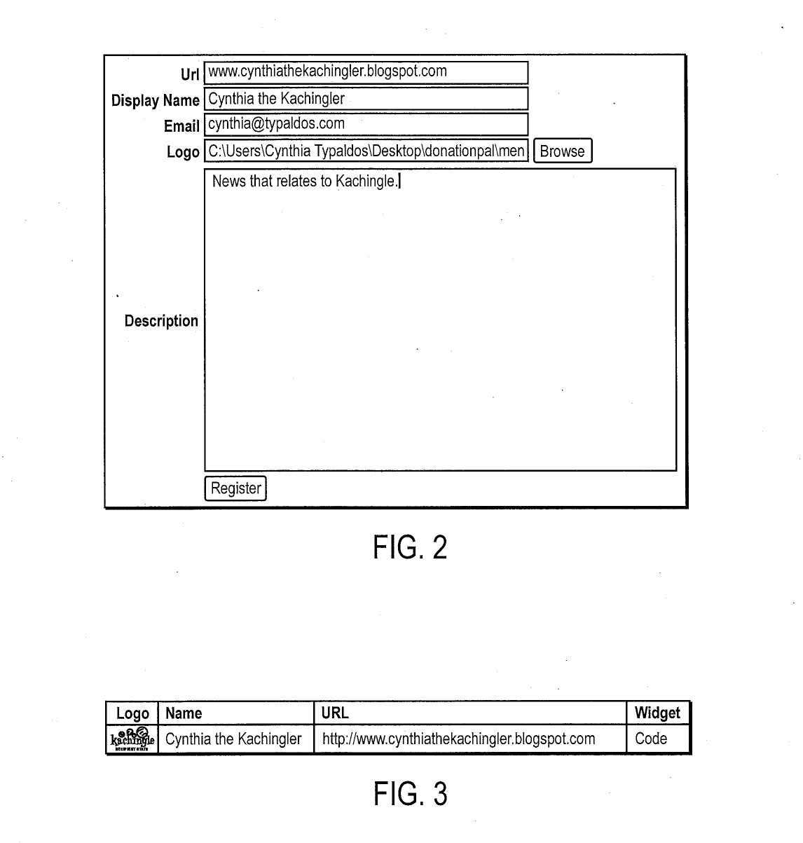

As shown in FIG. 2 screenshot of a registration page, this user is also a Recipient so s/he starts the process of signing up a site that s/he owns as an ENBVCS Recipient Site by providing basic information.

Initially a user will be able to choose only one Payment Service for their both behaviors as a Contributor and/or Recipient. However in later revisions, a user who is also a Recipient will be able to set a different Payment Service for each Recipient Site that s/he owns/manages.

Although the URL is shown in the example, the domain space included in a particular Recipient Site is not URL specific—it is simply wherever (e.g. the webpages) on which the Recipient chooses to place this particular Medallion. For instance, a single Medallion could include many urls and in fact many sites (or blogs or whatever). And specific site (or blog or url or whatever) could be divided up into multiple Recipient Sites. For instance the NYTimes could have each section (e.g. Technology) have its own. Medallion, each blog have its own Medallion, each columnist have his/her own Medallion or not.

### Get Recipient Site Medallion Widget Code

As shown by FIG. 3, clicking on the link “Code” provides the user with the html code necessary to install the Medallion Widget on his/her content site (in this case a blog hosted by Blogger).

### Copy Recipient Site Medallion Widget Code

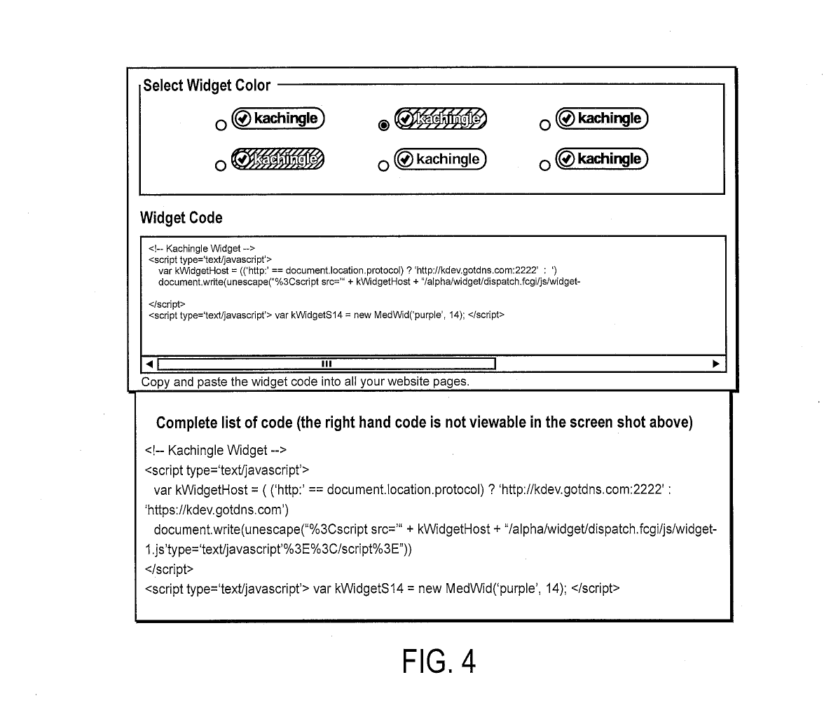

As shown by FIG. 4, the user selects a color/style of Medallion Widget and copies the Medallion Javascript code. In later revisions there will be more choices (e.g. size, shape, color, etc.).

### Pasting the Medallion Widget into the Recipient Site

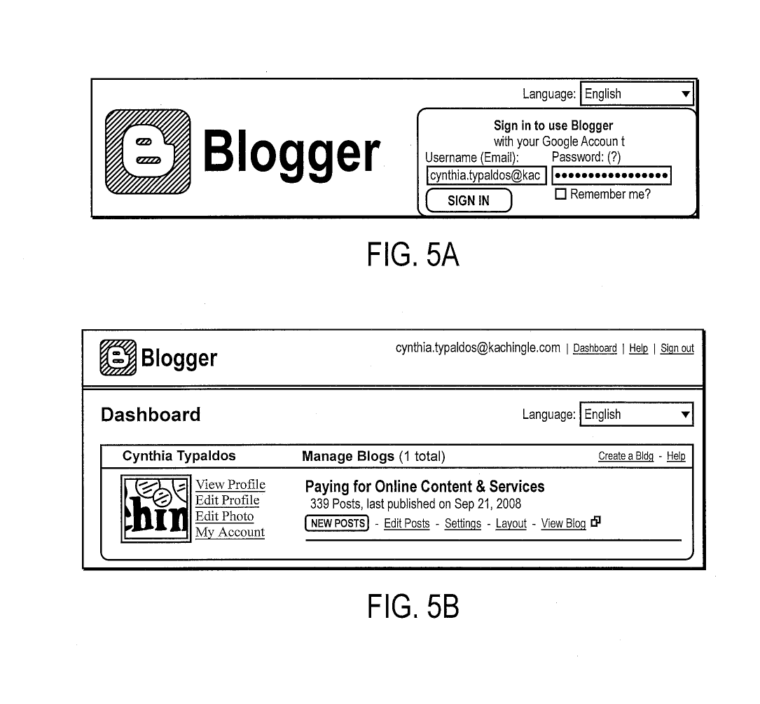

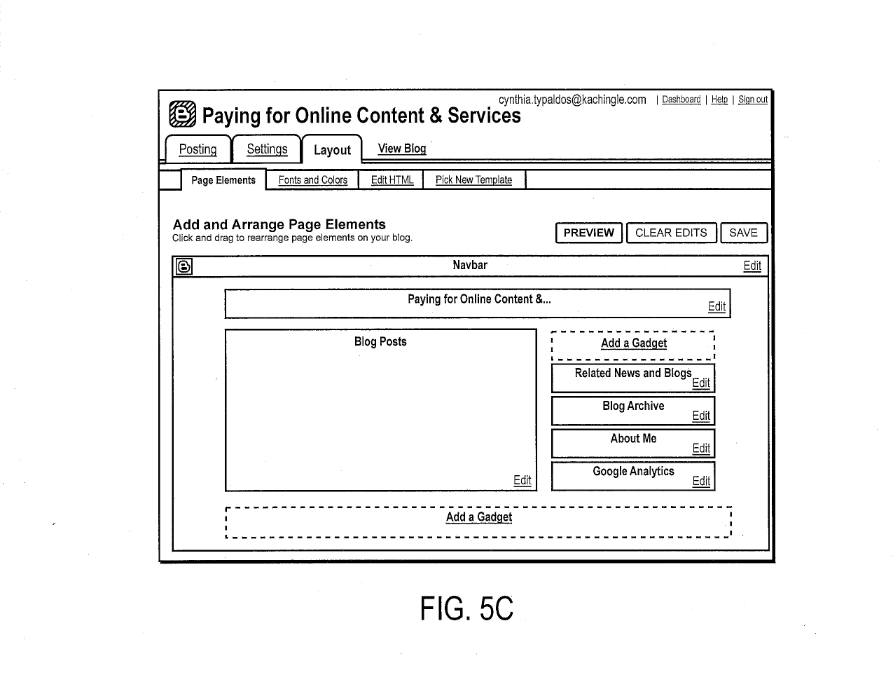

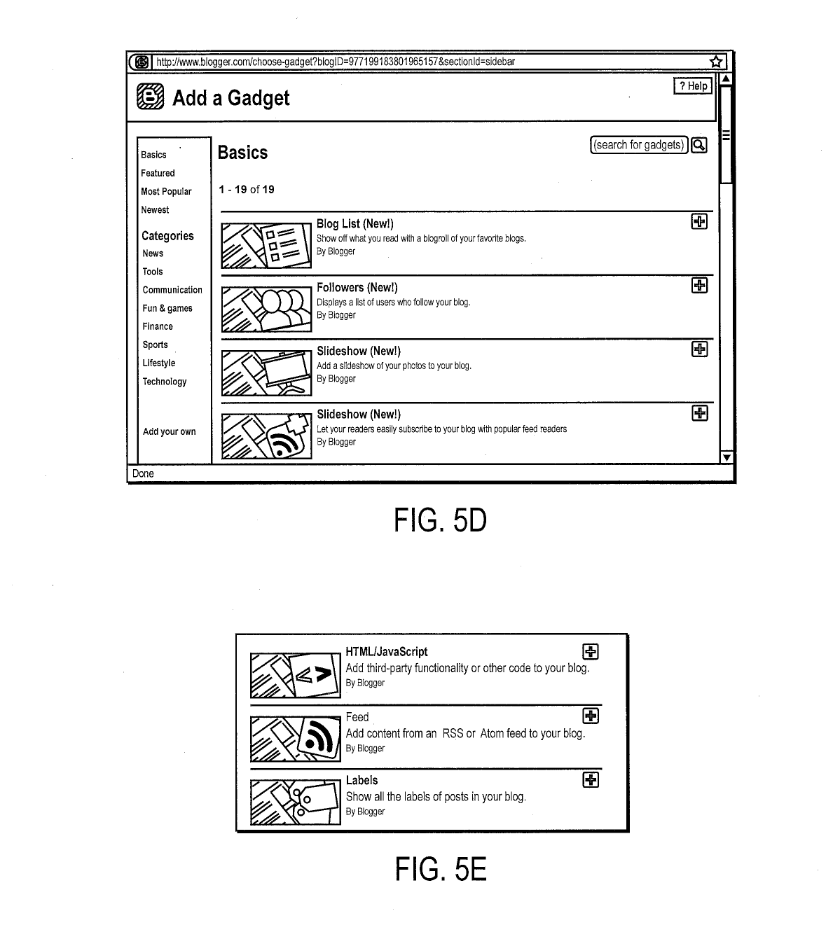

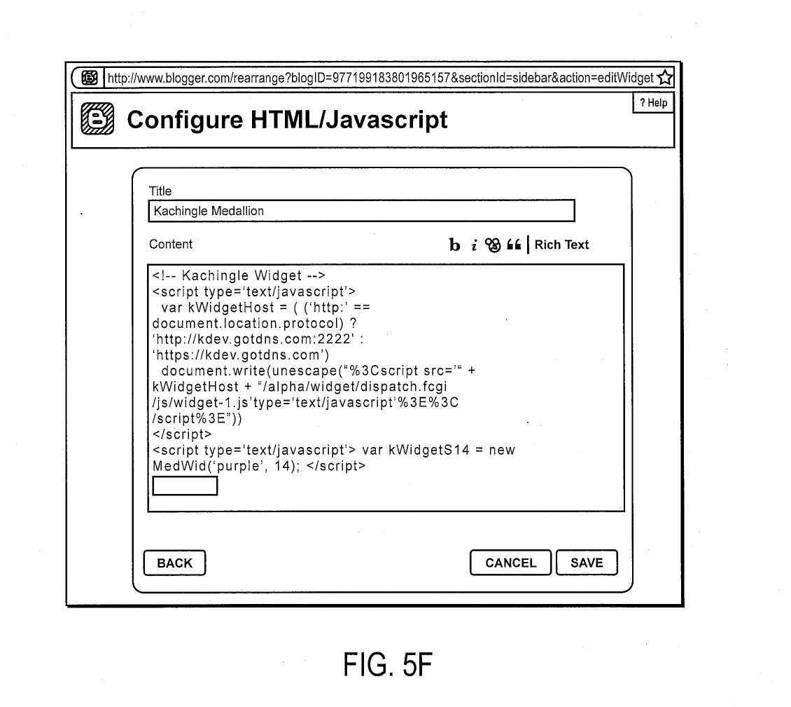

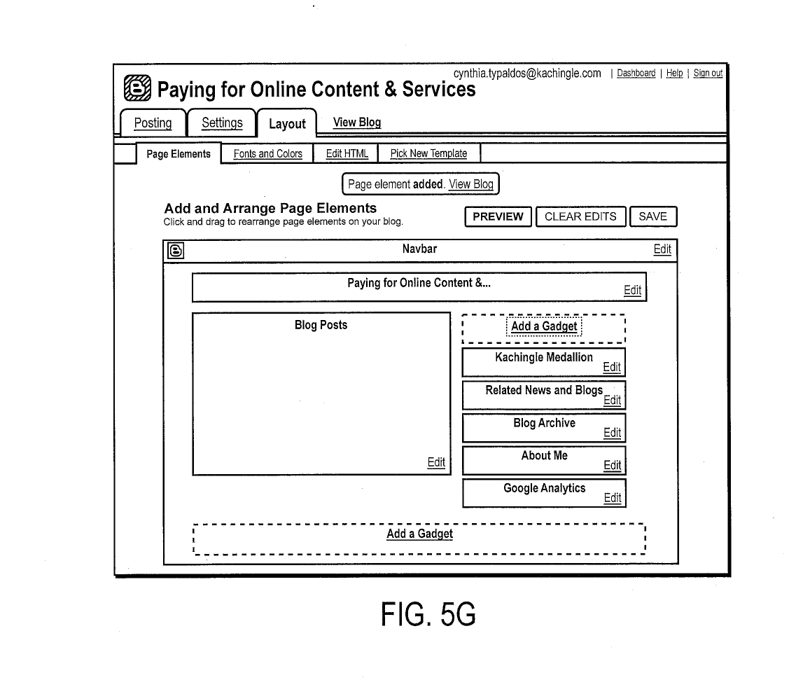

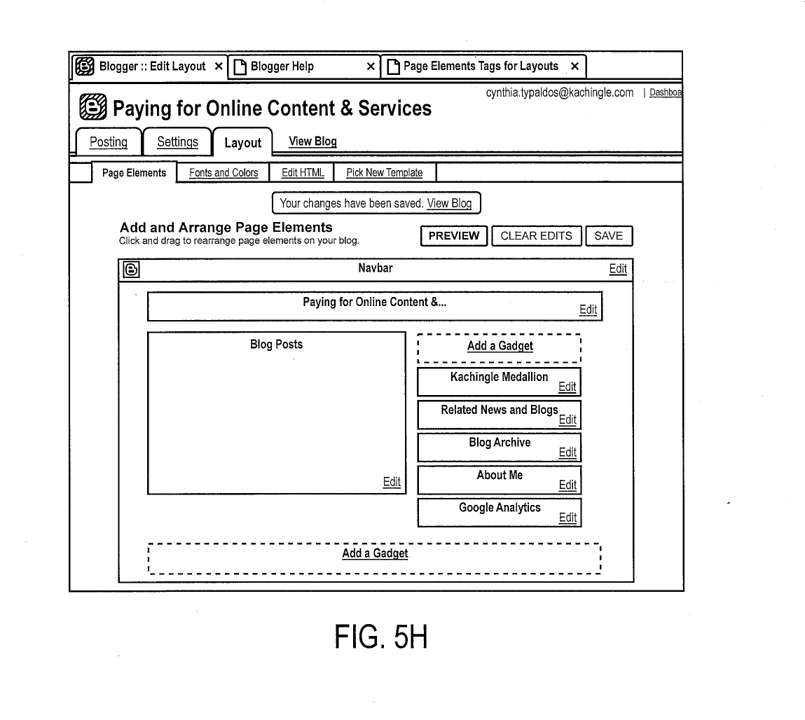

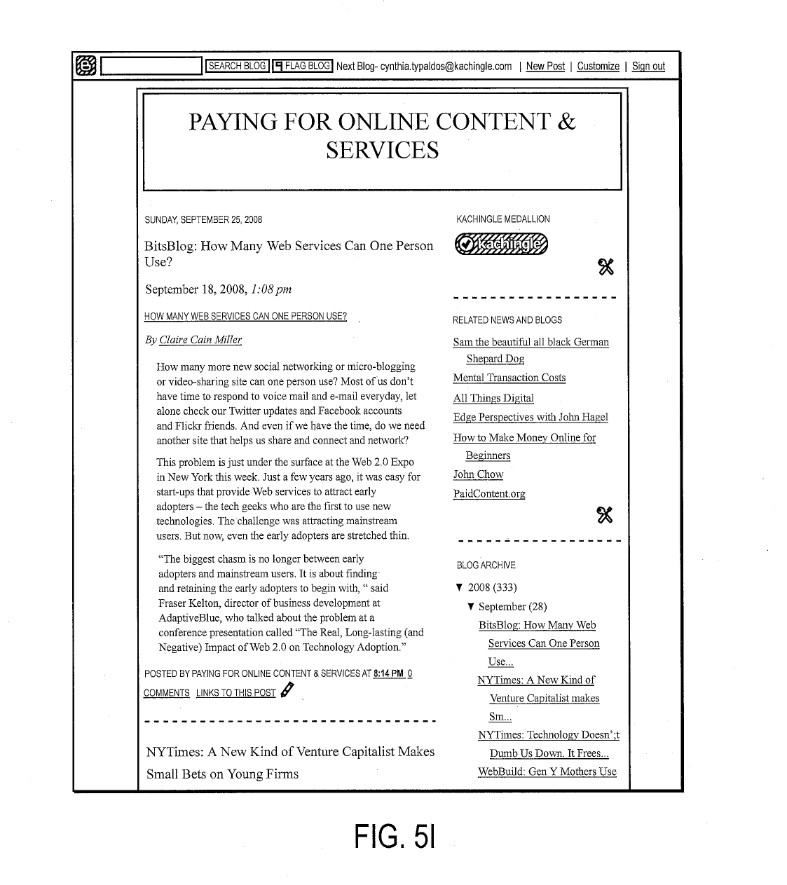

As shown by FIGS. 5(a) to (i), this illustrates how a user pastes a Medallion Widget into a Recipient Website. First the user must gain access to the template or html area of his/her Recipient Site. The example shown here is for Blogger, a popular blogging tool and hosted site owned by Google. The user logs into his/her blog using the Blogger website, as shown by FIG. 5(a). The user then is taken by Blogger to the blog management page, as shown by FIG. 5(b). The user goes to the “layout” management section, as shown in FIG. 5(c) In blogger, widgets are called “gadgets”. The user wants to add the ENBVCS Widget to his/her blog so s/he clicks on “Add a Gadget”. Blogger provides a popup window to “Add a Gadget”, shown in FIG. 5(d).

It should be understood that words used herein are limited by current vocabulary. These expression may evolve and include other expressions using the slogan word (such as the fanciful word “Kachingle”), in part or in full, and/or combined with the notion of “widget” and “gadget”. All permutations are intended to be within the scope of the embodiments described herein.

Further down on this page is the capability to “Add HTML/Javascript”, as shown in FIG. 5(e). The user clicks on this link. By clicking save, the ENBVCS Medallion Widget Javascript code is added, which is shown in FIG. 5(f). There are other ways than the cut'n paste mechanism shown herein, such as automatic insertion if allowed by the hosting system. Further, while in this example operation is described adding a Medallion Widget to a blog, the embodiments are not so limited, as discussed elsewhere herein. Administrative view from the ENBVCS server of blog template now shows that the ENBVCS Medallion has been added to the blog, as shown in FIG. 5(g) by the reference to “page element added” and that the changes have been saved, as shown in FIG. 5(h) by the reference to “Your changes have been saved.” User now views blog to see the just added the ENBVCS Medallion Widget, as shown in FIG. 5(i).

### Medallion Functionality—Active and Inactive State

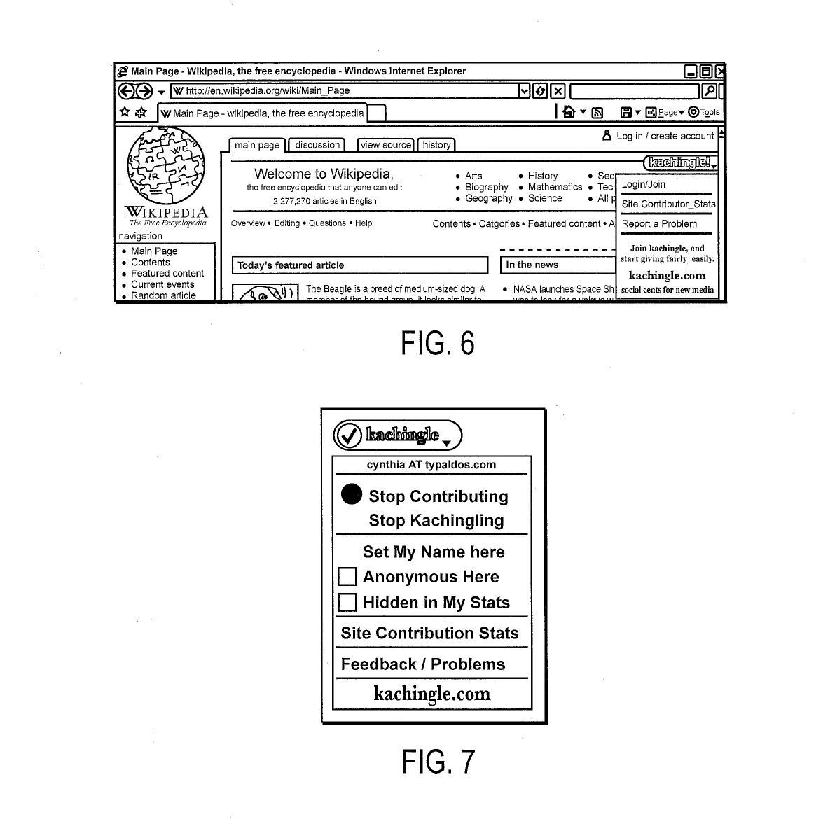

Once the Medallion is installed on a Recipient Site it goes into one of two modes depending on the status of the visitor to that site.
inactive (plus dropdown menu form)
active (plus dropdown menu form)—as is shown in FIG. 6, with a “friends and family” dropdown menu version shown in FIG. 7.

The Medallion Widget determines which state to present to the user depending on the presence and status of a “cookie” in the user's browser. This could be done using other mechanisms, such a browser plug-in client or an exchange with the server to get the information.

If the cookie tells the Medallion that the user state is inactive, then: Inactive means the Medallion is not tracking the user behavior because visitor is not a registered ENBVCS user, or is a registered user but one who has turned tracking ON.

In the inactive Medallion state, the user (or visitor) can do a number of functions such as:
login (if already a registered user)
join (if not yet a registered user)
view the “My Contributors Widget”
report a problem
view other relevant information such as a marketing message from the ENBVCS

If the cookie tells the Medallion that the user state is active, then: Active means the Medallion is tracking the user behavior because visitor is a registered ENBVCS user who has turned tracking ON.

In the active Medallion state, the user can do a number of functions including and not limited to:
turn tracking on and off
turn contributing to this Recipient Site on and off
create and set a “special name” for this Recipient Site only (for display in the “My Contributors Widget”)
set user name for this Recipient Site only to be “anonymous”
hide this Recipient Site in the public viewable version of this user's “My Recipients Widget”
view the “My Contributors Widget”
report a problem, send feedback
view user name
view Recipient Site name (not shown)
link to Kachingle.com website
link to his/her account area on the ENBVCS website
and other functions

Note that the user can also visit his/her account area on the ENBVCS website and modify things there too/instead.

It is also pointed out that the special name is chosen by the user for a particular Recipient Site. It is expected that special names will NOT be unique across the entire ENBVCS ecosystem. And in fact, they could even be the same on a particular Recipient Site, although this would be somewhat unusual.

For instance a user A's special name on the dogsrule blog is chihuahua. And user B's special name on the chihuahualovers is also chihuahua. The special name takes into account that regular commenters to sites have special names, but these are not unique across ALL sites although they are usually unique on a particular site. In one embodiment, of the ENBVCS system there is not a mechanism to link their actual name on that site to their special name, they have to enter it manually. In another embodiment an integrated mechanism is used, such as by partnering with content management tools, such as Blogger, to link a Contributor with their special name on that site.

When the Medallion is in the Active State, it automatically performs the following functions:
notes that the user has visited the site and reports this information back to the ENBVCS Server
sets the user specific visible information (e.g. username)
handles any feedback from the user (e.g. change Contributing from ON to OFF)
provides various kinds of feedback to the user (for example, the sound of jingling coins if Contributing is ON *AND* perhaps modified by an algorithm such as the “attention tracking” algorithm)

### Medallion Tracking Mechanism

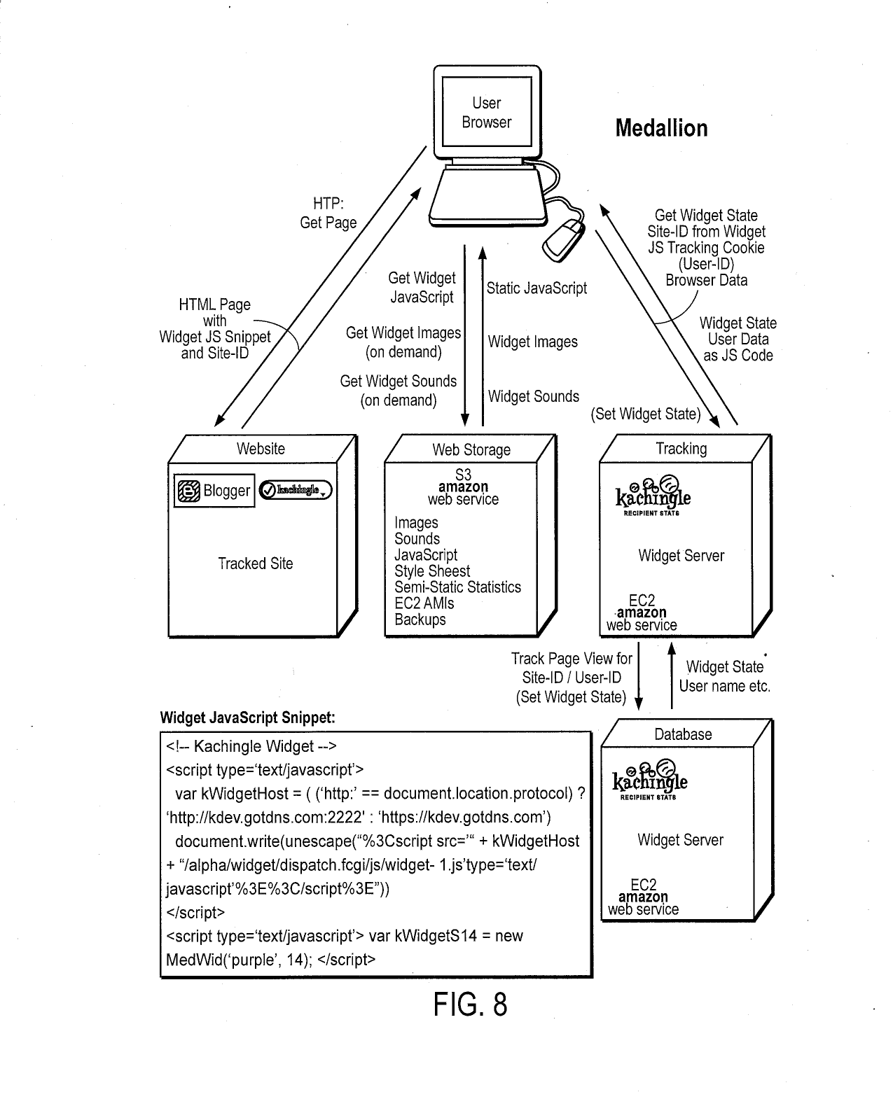

FIG. 8 describes the data flow when a user opens a page that includes the ENBVCS widget. The flow is as follows:
The user gets a page which includes the widget JS (including a valid Site identifier)
The browser then downloads all the static data from the static asset servers. The data downloaded includes, but is not limited to, the widget script, static images, sounds, style sheets, etc. . . .
The script then connects to the widget server, passing the site ID, as well as the tracking cookie, plus a set of data regarding the user environment, including, but not limited to, screen size, resolution, browser agent, flash availability, referrer, etc. . . . .
The widget server stores this data inside the tracking database, and returns a Javascript code, in order for the Javascript widget to update itself according to the user widget state.

### Medallion Token Distribution Based on Tracking Data

User ABC Tracking Data (Tracking turned ON)

| | | Visits with | Visits with | |
|---|---|---|---|---|
| | | Contributing | Contributing | |
| Recipient Site | Date | ON | OFF | Other . . . |
| samtheblackgsd.com | Sep. 25, 2008 | 4 | 0 | |
| wikipedia.com | Sep. 25, 2008 | 2 | 0 | |
| samtheblackgsd.com | Sep. 26, 2008 | 2 | 1 | |
| newoldage.blogs.nytimes.com | Sep. 27, 2008 | 2 | 0 | |
| wikpedia.com | Sep. 27, 2008 | 0 | 1 | |

The above illustrates a table of Medallion Token Distribution based on Tracking Data

This example shows 3 days of tracking activity for user “ABC”. This data can be used in a myriad of ways to allocate Tokens from the user (Contributor) to the Recipient Sites. The Medallion can track other data in addition to (or instead of) visits—e.g. page views, time on Recipient Site, etc.

Note that the Tracking data is just some of the user visible part of a complete Analytics Architecture can be leveraged in a large number of ways (see ADPLACEMENT and SEARCHIMPROVEMENT).

One allocation is by “Days Visited”, however many other allocations are possible (in fact there are an infinite variety of allocations), examples are page views, type of Recipient Site e.g. non-profit vs. for-profit, current total of Points, heavier weighting towards sites whose name starts with the letter “A” and so on.

It is even possible that we can allow users and third party developers to define their own allocation algorithm. For instance, a user who loves dogs could award triple points to all Recipient sites that have the tag of “dog”.

### Example

### Medallion Token Distribution Using “Days Visited” Criteria

This mechanism of distributing Tokens amongst the Recipient Sites is meant to be a reasonable proxy for value received by the user. For each day that the user visited a Recipient Site (with Contributing ON), that Recipient Site receives 1 Token. The above table then can be easily translated into Tokens, as shown in the table below:

User ABC Tokens using “Days Visited” Algorithm

| Recipient Site | Date | Tokens | Explanation |
|---|---|---|---|
| samtheblackgsd.com | Sep. 25, 2008 | 1 | At least one visit on this day |
| | | | with Contributing ON |
| wikipedia.com | Sep. 25, 2008 | 1 | At least one visit on this day |
| | | | with Contributing ON |
| samtheblackgsd.com | Sep. 26, 2008 | 1 | At least one visit on this day |
| | | | with Contributing ON |
| newoldage.blogs.nytimes.com | Sep. 27, 2008 | 1 | At least one visit on this day |
| | | | with Contributing ON |
| wikpedia.com | Sep. 27, 2008 | 0 | No visits this day with |
| | | | Contributing ON |

Total Tokens provide to Contributor ABC's Recipient Sites = 4
Tokens for samtheblackgsd.com = 2 (50% of total)
Tokens for wikipedia.com = 1 (25% of total)
Tokens for newoldage.blogs.nytimes.com = 1 (25% of total)

Translation of Tokens into Points

At periodic intervals for each user (which intervals are preferably customizable), Tokens are translated into Points and disbursed to the Recipient Site (actually they may be held for disbursement for a variety of reasons such as payment cycle processing but they are virtually disbursed and are used to update the Recipient Sites' “Contributor Display Widget” on a regular, such as daily, basis).

Users are allocated total Points by any mechanism the ENBVCS is programmed to support . . . in this example users have been allocated (or purchased) different amounts of Points.

Contributor total Points to allocate

A—10 Points
B—20 Points
C—50 Points
D—12.52 Points
E—100 Points

The Points allocated to each Recipient Site from each user are modified by the Token percentage.

For example, for Contributor A:
Recipient Site 1 received 50% of his/her Tokens
Recipient Site 2 received 0% of his/her Tokens
Recipient Site 3 received 25% of his/her Tokens
Recipient Site 4 received 0% of his/her Tokens
Recipient Site 5 received 25% of his/her Tokens

Token Table by Contributor: Contributors A-E, Recipient Sites 1-5

| | Recipient | Recipient | Recipient | Recipient | Recipient |
|---|---|---|---|---|---|
| | Site 1 | Site 2 | Site 3 | Site 4 | Site 5 |
| Contributor | Token % | Token % | Token % | Token % | Token % |
| A | 50 | 0 | 25 | 0 | 25 |
| B | 56 | 44 | 0 | 0 | 0 |
| C | 0 | 20 | 20 | 40 | 20 |
| D | 0 | 2 | 10 | 88 | 0 |
| E | 99 | 0 | 0 | 1 | 0 |

Points Table by Contributor: Contributors A-E, Recipient Sites 1-5

| Contributor | Recipient | Recipient | Recipient | Recipient | Recipient |
|---|---|---|---|---|---|
| total Points | Site 1 | Site 2 | Site 3 | Site 4 | Site 5 |
| to allocate | Points | Points | Points | Points | Points |
| below | Distributed | Distributed | Distributed | Distributed | Distributed |
| A - 10 Points | 5 | | 2.50 | | 2.50 |
| B - 20 Points | 11.29 | 8.71 | | | |
| C - 50 Points | | 9.99 | 10.01 | 20 | 10 |
| D - 12.52 Points | | .31 | 1.21 | 11 | |
| E - 100 Points | 99.01 | | .01 | .98 | |

Complete Token Table (rounded) which is applied to the Points to create the above Points Table as follows: Total Points for Contributor X * Token % for Recipient Site Y.

Where X=A, B, C, D, E and correspondingly Y=1, 2, 3, 4, 5.

Below is the same Points Table but done from the view of the Recipient Sites.

Points Table by Recipient Site: Contributors A-E, Recipient Sites 1-5

| Points for each | From | From | From | From | From |
|---|---|---|---|---|---|
| Recipient Site | Contributor A | Contributor B | Contributor C | Contributor D | Contributor E |
| 1—115.30 total | 5 | 11.29 | | | 99.01 |
| 2—19.01 total | | 8.71 | 9.99 | .31 | |
| 3—13.73 total | 2.50 | | 10.01 | 1.21 | .01 |
| 4—31.98 total | | | 20 | 11 | .98 |
| 5—12.50 total | 2.50 | | 10 | | |

These Points can now be allocated as is to each Recipient Site or further algorithms can be applied (e.g. only the top 3 Recipient Sites get any Points, the ones allocated to other than the top 3 Recipient Sites are proportionately distributed across the top 3).

### Points as Monetary Contributions

In one instantiation, Points can actually be purchased by Contributors. For example, 1 Point=$1. So 10 Points are a Contribution of $10. This money can then be distributed to the Recipient Sites as shown previously to create a system of voluntary payments from Contributors to Recipient Sites. If a user contributes to more sites, in one embodiment the value of each point goes down if the overall contribution is fixed, although it will be understood that other usage algorithms can be implemented.

Note that Transaction fees will exist (for example, payment service transaction fees, ENBVCS transaction fees) but these are just a permutation of the application of the attention tracking algorithm and subsequent conversion of Tokens applied to Points as $.

### Points Distribution Notification to Contributor

Once a Contributor allocation cycle is completed (e.g. once/month), the ENBVCS notifies the user that the Points are about to be distributed (virtually, that is they are accumulating in bit buckets) to the Recipient Sites. The ENBVCS gives the Contributor a reasonable amount of time to modify or stop the distribution.

In this example, Points are $ purchased by the Contributor, and the notification is done via a variety of mechanisms such email, instant messaging, SMS and so on with further information residing in the user account area of the ENBVCS website. The attention tracking algorithm used is “Days Visited” and the Points are $. Here, the Contributor has paid $10 for his/her Points, and the “Days Visited” algorithm has applied the Token % to the $10 and derived a $ amount to be delivered to each Recipient (minus transaction fees which are not shown in this table).

The user may be given options to modify or manage this payout such as:
remove any or some Recipient Sites from the payout (and readjust the allocations for the remaining sites proportionately)
cancel the payout
modify or replace the attention tracking allocation algorithm
add additional Points (e.g. $)

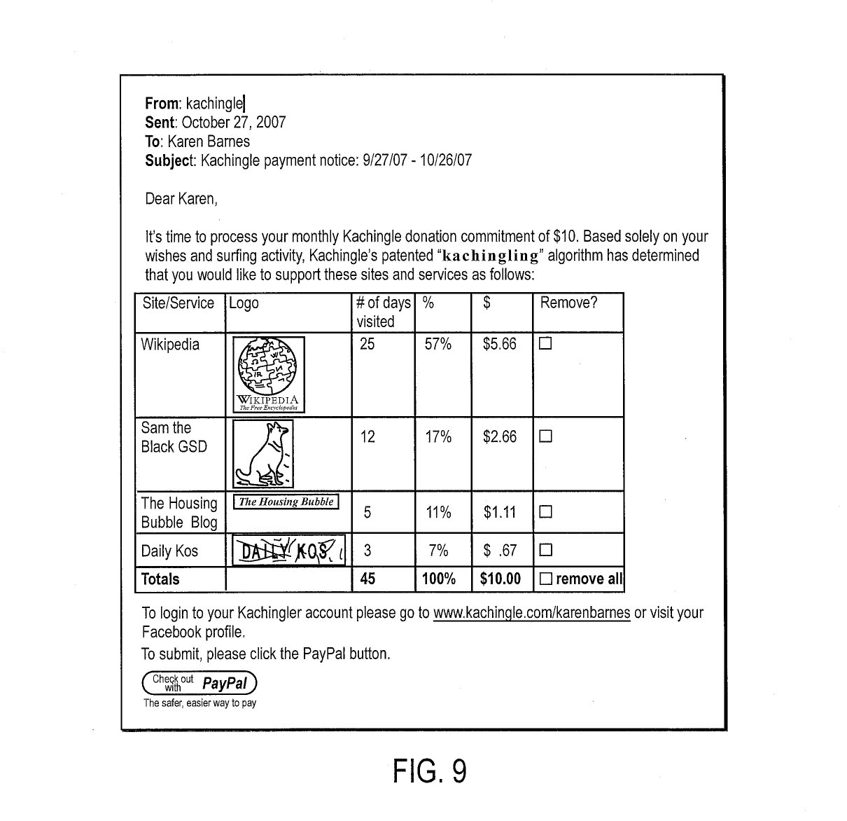

In the example here, with reference to FIG. 9, where Points are $, the processing also includes a financial transaction from the user's payment service (of $10) into the Kachingle financial system.

### Points Distribution Notification to Recipient (for a Specific Recipient Site)

On a regular basis for each Recipient Site (e.g. once/month or as often as selected by the Recipient) or when Points achieve a certain level (or any other criteria), the ENBVCS distributes the Points that have been accrued from the Contributors to a Recipient Site and notifies the Recipient of the distribution.

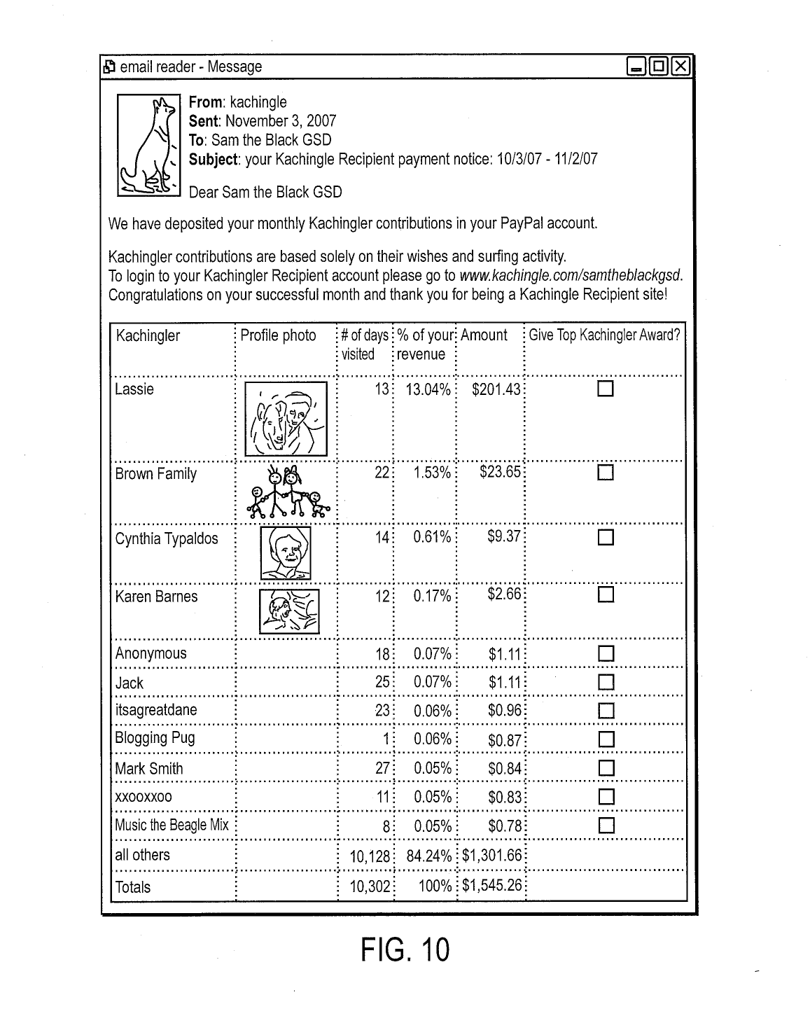

In this example, with reference to FIG. 10, an email (but it could be in any form of electronic communication such as IM, SMS, etc.) is sent to the Recipient Site with some information regarding the distribution. The Recipient (owner of the Recipient Site) can also login to his/her account to find this information.

If the Points are $, then there is an accompanying financial transaction where the total $ accrued by this Recipient Site from all Contributors are deposited in the Recipient's payment service. All financial transactions include transaction fees, which are not shown in this particular example.

Previous is a sample notification email to a Recipient about a Points distribution event to the Recipient Site SamtheBlackGSD.com with $ (as Points). In this example, the attention tracking allocation algorithm is “Days Visited”.

The Recipient may have numerous options to apply that will then be displayed on that Recipient Site's “Contributor Display Widget” and/or each Contributor's “Recipient Display Widget”. An example shown here is the option to declare a Contributor as a “top Contributor” this month (for this particular Recipient Site).

This underlying polling architecture reveals knowledge on a daily (or any timeframe) basis what people are ready to pay for now.

### Display of Points on “My Recipients Widget”

A user who is a Contributor can access and view their current and historical distribution of Tokens/Points/$.

Additionally, the user has the option of making some or all of this information public where it resides (on the ENBVCS website), and/or turning it into widgetized form for placement on a social networking profile, blog, website, or any other internet location that s/he has access to and allows html-based code insertion, including email/mobile device signatures. The technology to place these widgets elsewhere is the same or very similar to that shown to install the Medallion Widget on a Recipient Site.

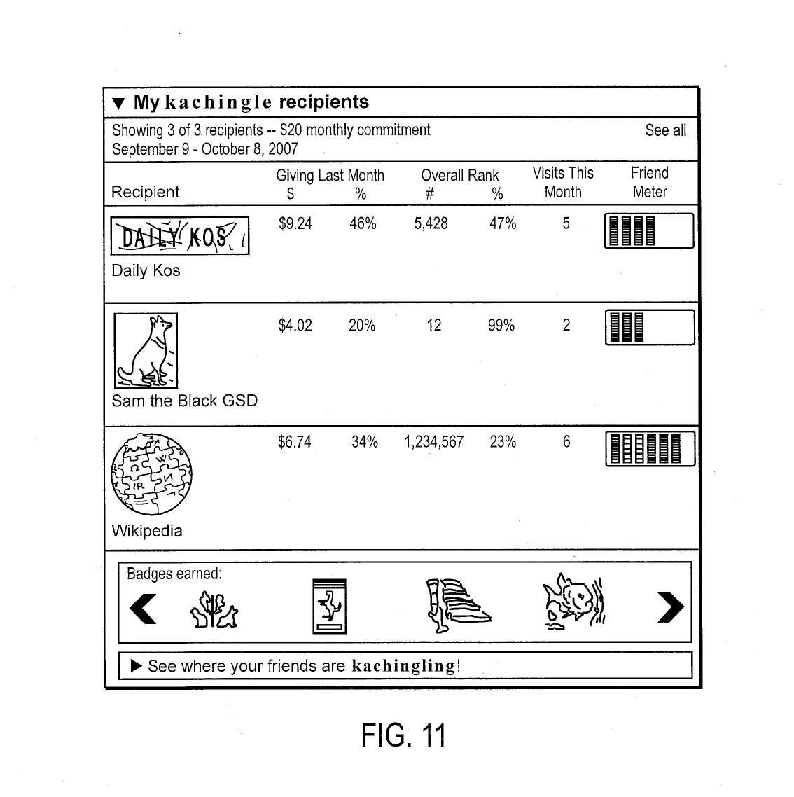

The example, with reference to FIG. 11, shows application of the “Daily Visits” attention tracking algorithm, with Points as $. The user has many options in how this public version of the information appears such as:
hiding some or all of the Recipient Sites
modifying the look, order of columns and rows, etc.
hiding some or all of the specific information
and so on . . . .

This example also shows additional information that could be displayed by the ENBVCS based on other features, for example, Badges earned by this Contributor, a Friendmeter which measures the overlap of this Contributor's Recipient Sites compared with this Contributor's social networking friends, etc.

### User Account View of “My Recipients Widget”

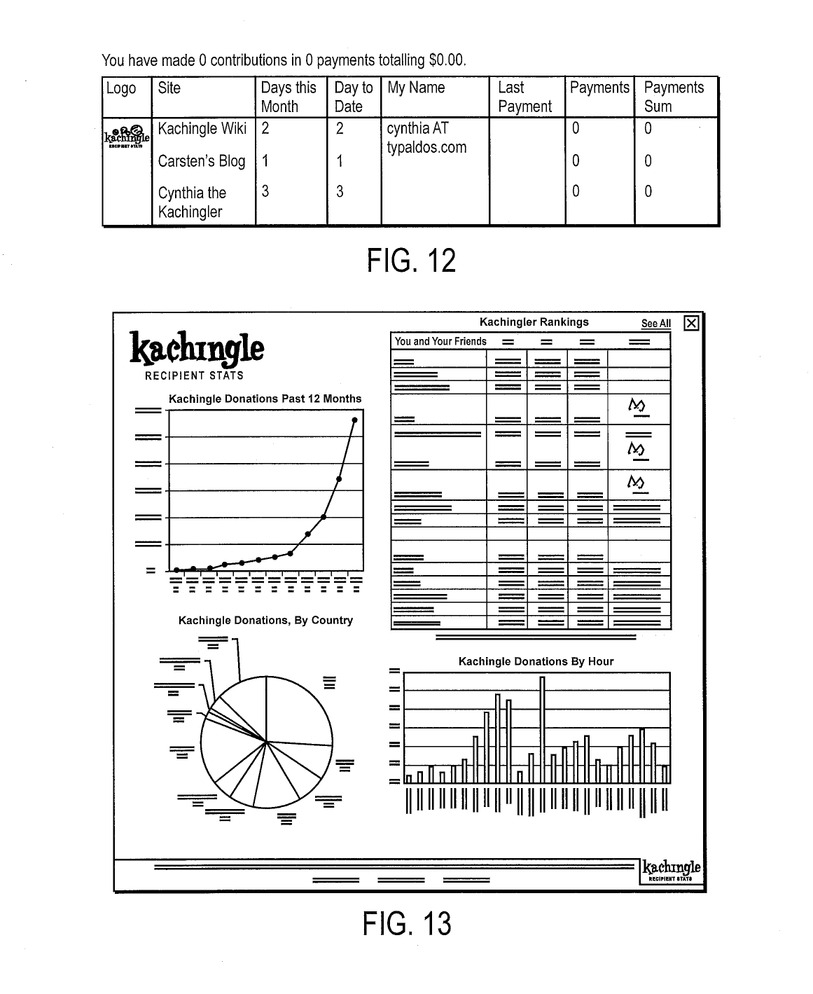

The FIG. 12 table shows the type of data that is stored on the ENBVCS website and accessible to the Contributor (privately). In this example the Contributor can view his/her tracking data with the “attention tracking” algorithm applied (here it is “Days Visited”). For each Recipient Site where the user has set contributing on, data is being gathered and shown for a certain timeframe—here the last month, and also since the beginning of this user's registration.

The “My Name” field is can be set by the user as:
username (default, shown as blank in table)
name on this site
anonymous

The Contributor can also choose to allow a link from this user field to his/her “My Recipient Widget”. For example, if the Contributor chooses to use his/her “username” this would include a link as the default, if he/she choose “anonymous” there would not be a link the default, and if s/he chooses a “name on this site” (e.g. HappyDog) the ENBVCS would prompt the user to choose link/no link when accepting this special name. [Not shown in this table.]

The Contributor can also choose to hide a Recipient Site in the public view (which is the “My Recipient Widget” and previously described)—there will be a show/hide button that can be toggled by the Contributor for each Recipient Site.

Also visible to the Contributor will be a variety of information about his/her payments (Points if set as $ values).

### Display of Points on “My Contributors Widget”

The “My Contributors Widget” for each Recipient Site displays information about the Contributors and their Points allocated to this Recipient Site. This information, shown in FIG. 13, is updated on a regular basis, such as daily and can also be real-time.

While the information resides on the ENBVCS Server, it can also be widgetized by the Recipient and placed elsewhere, in a similar manner as the “My Recipients Widget”.

The basic information in the “My Contributors Widget” is the mirror of the all of information shown in the “My Recipients Widgets” for ALL Contributors to this particular Recipient Site.

In the example shown above the “My Contributors Widget” has recognized that a Contributor is viewing the data (thru the use of cookie technology) and pulled out some specific information for that Contributor (e.g. “You and Your Friends”). However the main gist of the table is the list of all Contributors, the Points allocated (in this example Points are $), and the date of the allocation (not shown).

The other display data, charts and graphs are derivatives of this basic data.

The Recipient may or may not be able hide this data from anyone—it is viewable by all visitors to the Recipient Site from a link in the Medallion Widget or some other simple link mechanism or a widgetized version of this data.

In this example, all Contributions and all Contributors are included [although some information may be collapsible/expandable for ease of use]. We reserve the ability though to tailor the information that is shown in any way.

Contributors can choose to display one of several “names” based on the Recipient Site (this was explained previously in the section “Medallion Functionality—Active State”:
username
name on this site
anonymous

If a link appears on the Contributor name, it goes to that Contributor's “My Recipient Widget”. For example, if the Contributor chooses to use his/her “username” this would include a link as the default, if he/she choose “anonymous” there would not be a link the default, and if s/he chooses a “name on this site” (e.g. HappyDog) The ENBVCS would prompt the user to choose link/no link when accepting this special name.

Linking and Traversing of “My Recipients Widget” Part A

| | Recip- | Recip- | Recip- | Recip- | Recip- | Recip- |
|---|---|---|---|---|---|---|
| Contrib- | ient | ient | ient | ient | ient | ient |
| utor | Site 1 | Site 2 | Site 3 | Site 4 | Site 5 | Site 6 |
| A | R-1 | | R-3 | | R-5 | |
| B | R-1 | R-2 | | | | R-6 |
| C | | R-2 | R-3 | R-4 | R-5 | R-6 |
| D | | R-2 | | | | |
| E | R-1 | | R-3 | R-4 | | |

The above table shows which Contributors are providing Points to which Recipient Sites. Note that it is the mirror image of the table “Linking and Traversing of “My Contributors Widget” Part A”.

Linking and Traversing of “My Recipients Widget” Part B

| | | | |
|---|---|---|---|
| Contributor | Recipient | Recipient | Recipient |
| A | Site 1: | Site 3: | Site 5: |
| | Name | Name | Name |
| | plus | plus | plus |
| | URL link | URL link | URL link |

This above table shows more details of the type of information that is stored for each Contributor regarding which Recipient Sites s/he has provided Points to. Note that the “My Recipients Widget” can include links to the Recipient Site—in particular, that link can be to the “My Contributors Widget” for that Recipient Site. Anyone viewing this user's “My Recipient Widget” then has easy 1-click link access to the list of ALL Contributors to that Recipient Site.

This table can be displayed to the user and others (depending on privacy constraints set by the user) in a myriad of ways such as:
on the ENBVCS website
in a widgetized form which the user can place anywhere, for example, on a social networking profile

Linking and Traversing of “My Contributors Widget” Part A

| Recipient | Contrib- | Contrib- | Contrib- | Contrib- | Contrib- |
|---|---|---|---|---|---|
| Site | utor A | utor B | utor C | utor D | utor E |
| 1 | C-A | | C-C | | C-E |
| 2 | C-A | C-B | | | |
| 3 | | C-B | C-C | C-D | C-E |
| 4 | | C-B | | | |
| 5 | C-A | | C-C | C-D | |
| 6 | | | | | |

This above table shows which Recipient Sites have received Points from which Contributors. Note that it is the mirror image of the table “Linking and Traversing of “My Recipients Widget” Part A”.

Linking and Traversing of “My Contributors Widget” Part B

| | | | |
|---|---|---|---|
| Recipient | Contributor | Contributor | Contributor |
| 1 | A: plus URL | C: plus URL | E: plus URL |
| | link | link | link |

This table shows more details of the type of information that is stored for each Recipient Site regarding which Contributors have provided Points. Note that the “My Contributors Widget” can include links to the Contributor information—in particular, that link can be to the “My Recipient Widget” for that Contributor. Anyone viewing this user's “My Contributors Widget” then has easy 1-click link access to the list of ALL Recipient Sites for each Contributor (subject to privacy constraints imposed by the Contributor).

This table is available for display to all visitors to the Recipient site (although the exact name used for each Contributor and the presence of the link depends on privacy constraints set by the Contributor) in a myriad of ways such as:
on the ENBVCS website
in a widgetized form which the Recipient Site can place anywhere, for example, on the Recipient Site itself.

### Traversing Across “My Contributors Widget” and “My Recipients Widget”

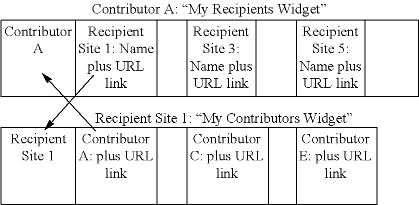

This table now shows how these two mirror image Widgets (the “My Contributors Widget” and the “My Recipients Widget” can be traversed by any internet user (assuming that the Contributor has not imposed specific privacy constraints) throughout the entire ENBVCS ecosystem for discovery and adventure.

For example, assume that a visitor Q arrives at Recipient Site 1 (e.g. SamtheBlackGSD Blog). That visitor views the list of Contributors to SamtheBlackGSD Blog and notices Contributor A (Cynthia). [Cynthia has set privacy off so there is a link on her username.] Visitor Q clicks on the link on Contributor A (Cynthia) and is sent to Cynthia's “My Recipient Widget”. Visitor Q then peruses Cynthia's “My Recipients Widget” and uses this information to discover new websites/blogs that are endorsed/supported by Cynthia. Visitor Q also traverses these links to find people of interest—e.g. users that are supporting particular websites/blogs. So Visitor Q now has a unique new tool for discovering people and websites/blogs of interest. And these endorsements of Recipient Sites are much more powerful than a recommendation as they are backed by a Points mechanism and based on actual user behavior

Interlinked “My Recipients Widgets” and “My Contributors Widget” Combined with an Attention Tracking Algorithm

Assume there are 5 Contributors (Karen, Cindy, Alex, John, Jens) and 4 Recipient Sites (A, B, C, D). The Contributors are contributing to the Recipients Sites as follows:

| | Recipient | Recipient | Recipient | Recipient |
|---|---|---|---|---|
| Contributors | Site A | Site B | Site C | Site D |
| Karen | x | x | | |
| Cindy | | x | | x |
| Alex | x | x | x | x |
| John | x | | x | x |
| Jens | | x | x | |

The Contributors' “My Recipients Widgets” look like this (columns only):

| Karen | Cindy | Alex | John | Jens |
|---|---|---|---|---|
| A | B | A | A | B |
| B | D | B | C | D |
| | | C | D | |
| | | D | | |

And the Recipient Sites' “My Contributors Widgets” look like this (columns only):

| Recipient | | | |
|---|---|---|---|
| Site A | Recipient Site B | Recipient Site C | Recipient Site D |
| Karen | Karen | Alex | Cindy |
| Alex | Cindy | John | Alex |
| John | Alex | Jens | John |
| | Jens | | |

### Add Interlinking:

The Contributors' “My Recipients Widgets” look like this (columns only):

| Karen | Cindy | Alex | John | Jens |
|---|---|---|---|---|
| A + link | B + link | A + link | A + link | B + link to this |
| to this | to this | to this | to this | site's “My |
| site's “My | site's “My | site's “My | site's “My | Contributors |
| Contributors | Contributors | Contributors | Contributors | Widget” |
| Widget” | Widget” | Widget” | Widget” | |
| B + link | D + link | B + link | C + link | D + link to this |
| to this | to this | to this | to this | site's “My |
| site's “My | site's “My | site's “My | site's “My | Contributors |
| Contributors | Contributors | Contributors | Contributors | Widget” |
| Widget” | Widget” | Widget” | Widget” | |
| | | C + link | D + link | |
| | | to this | to this | |
| | | site's “My | site's “My | |
| | | Contributors | Contributors | |
| | | Widget” | Widget” | |
| | | D + link | | |
| | | to this | | |
| | | site's “My | | |
| | | Contributors | | |
| | | Widget” | | |

And the Recipient Sites' “My Contributors Widgets” look like this (columns only):

| Recipient Site A | Recipient Site B | Recipient Site C | Recipient Site D |
|---|---|---|---|
| Karen + link to | Karen + link to | Alex + link to this | Cindy + link to |
| this user's “My | this user's “My | user's “My | this user's “My Recipients |
| Recipients | Recipients Widget” | Recipients Widget” | Widget” |
| Widget” | | | |
| Alex + link to this | Cindy + link to | John + link to this | Alex + link to this |
| user's “My | this user's “My | user's “My | user's “My Recipients |
| Recipients | Recipients Widget” | Recipients Widget” | Widget” |
| Widget” | | | |
| John + link to this | Alex + link to this | Jens + link to this | John + link to this |
| user's “My | user's “My | user's “My | user's “My Recipients |
| Recipients | Recipients Widget” | Recipients Widget” | Widget” |
| Widget” | | | |
| | Jens + link to this | | |
| | user's “My | | |
| | Recipients Widget” | | |

### Now Add the “Attention Tracking Algorithm”:

What has been added here is the POINTS (or $ if we are using money). So the value of each Recipient Site is now weighted by how many points have been assigned by its Contributors. Just interlinking them isn't very interesting . . . because we are all about assigning real VALUE.

This information creates the underlying data of our qualified interlinked network. That is, each link has a clear value assigned to it, based on the Points or $.

The Contributors' “My Recipients Widgets” look like this (columns only):

| Karen | Cindy | Alex | John | Jens |
|---|---|---|---|---|
| A + link to this | B + link to this | A + link to this | A + link to this | B + link to this site's “My |
| site's “My | site's “My | site's “My | site's “My | Contributors Widget” + |
| Contributors | Contributors | Contributors | Contributors | POINTS awarded by |
| Widget” + | Widget” + | Widget” + | Widget” + | this Contributor in |
| POINTS | POINTS | POINTS | POINTS | the last payout cycle |
| awarded by | awarded by | awarded by | awarded by | |
| this | this | this | this | |
| Contributor in | Contributor in | Contributor in | Contributor in | |
| the last payout | the last payout | the last payout | the last payout | |
| cycle | cycle | cycle | cycle | |
| B + link to this | D + link to this | B + link to this | C + link to this | D + link to this site's “My |
| site's “My | site's “My | site's “My | site's “My | Contributors Widget” + |
| Contributors | Contributors | Contributors | Contributors | POINTS awarded by |
| Widget” + | Widget” + | Widget” + | Widget” + | this Contributor in |
| POINTS | POINTS | POINTS | POINTS | the last payout cycle |
| awarded by | awarded by | awarded by | awarded by | |
| this | this | this | this | |
| Contributor in | Contributor in | Contributor in | Contributor in | |
| the last payout | the last payout | the last payout | the last payout | |
| cycle | cycle | cycle | cycle | |
| | | C + link to this | D + link to this | |
| | | site's “My | site's “My | |
| | | Contributors | Contributors | |
| | | Widget” + | Widget” + | |
| | | POINTS | POINTS | |
| | | awarded by | awarded by | |
| | | this | this | |
| | | Contributor in | Contributor in | |
| | | the last payout | the last payout | |
| | | cycle | cycle | |
| | | D + link to this | | |
| | | site's “My | | |
| | | Contributors | | |
| | | Widget” + | | |
| | | POINTS | | |
| | | awarded by | | |
| | | this | | |
| | | Contributor in | | |
| | | the last payout | | |
| | | cycle | | |

And the Recipient Sites' “My Contributors Widgets” look like this (columns only):

| Recipient Site A | Recipient Site B | Recipient Site C | Recipient Site D |
|---|---|---|---|
| Karen + link to | Karen + link to | Alex + link to this | Cindy + link to |
| this user's “My | this user's “My | user's “My | this user's “My |
| Recipients | Recipients Widget” + | Recipients Widget” + | Recipients Widget” + |
| Widget” + | POINTS | POINTS | POINTS |
| POINTS awarded | awarded by this | awarded by this | awarded by this |
| by this | Contributor in the | Contributor in the | Contributor in the |
| Contributor in the | last payout cycle | last payout cycle | last payout cycle |
| last payout cycle | | | |
| Alex + link to this | Cindy + link to | John + link to this | Alex + link to this |
| user's “My | this user's “My | user's “My | user's “My |
| Recipients | Recipients Widget” + | Recipients Widget” + | Recipients Widget” + |
| Widget” + | POINTS | POINTS | POINTS |
| POINTS awarded | awarded by this | awarded by this | awarded by this |
| by this | Contributor in the | Contributor in the | Contributor in the |
| Contributor in the | last payout cycle | last payout cycle | last payout cycle |
| last payout cycle | | | |
| John + link to this | Alex + link to this | Jens + link to this | John + link to this |
| user's “My | user's “My | user's “My | user's “My |
| Recipients | Recipients Widget” + | Recipients Widget” + | Recipients Widget” + |
| Widget” + | POINTS | POINTS | POINTS |
| POINTS awarded | awarded by this | awarded by this | awarded by this |
| by this | Contributor in the | Contributor in the | Contributor in the |
| Contributor in the | last payout cycle | last payout cycle | last payout cycle |
| last payout cycle | | | |
| | Jens + link to this | | |
| | user's “My | | |
| | Recipients Widget” + | | |
| | POINTS | | |
| | awarded by this | | |
| | Contributor in the | | |
| | last payout cycle | | |

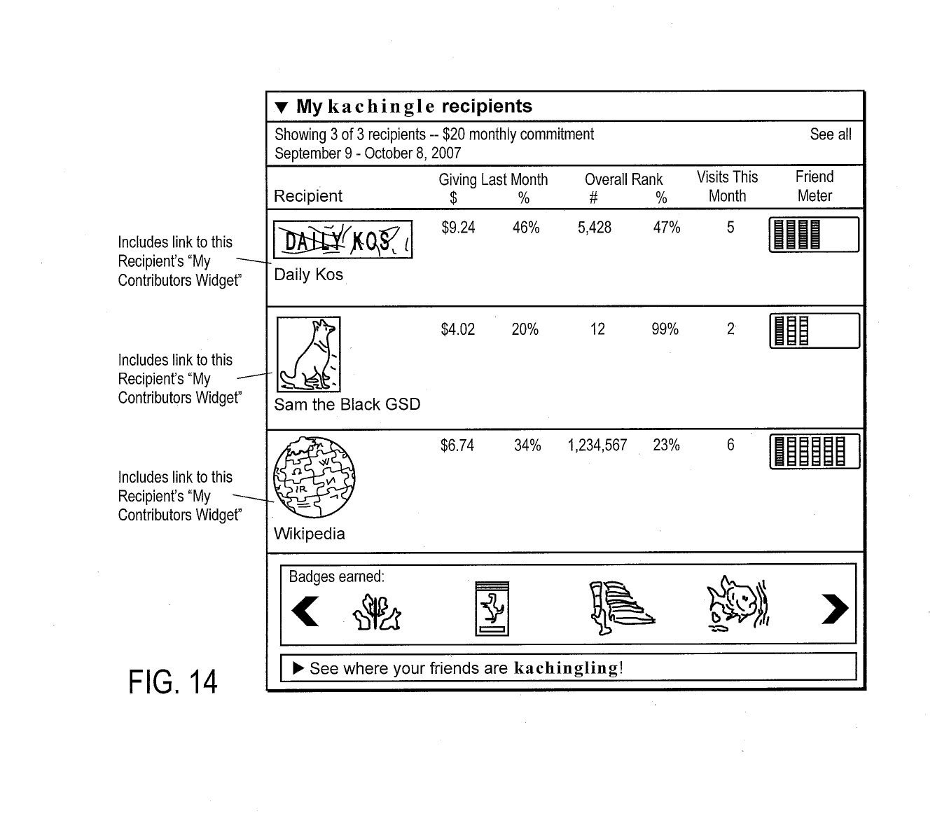

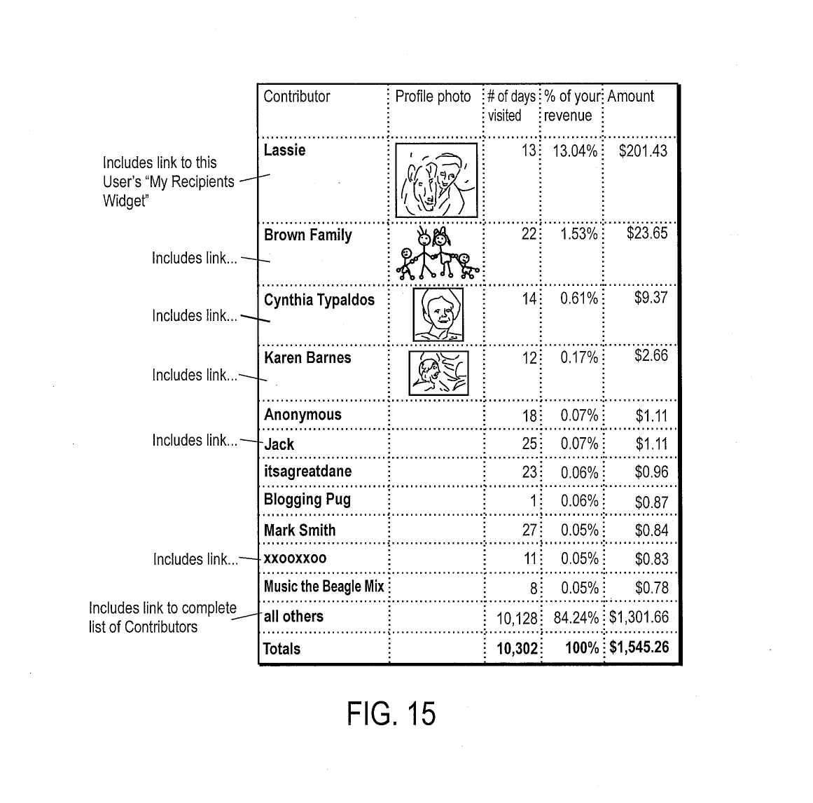

Shown in FIG. 14 is a Mockup of “My Recipients Widget” showing Interlinking COMBINED with an Attention Tracking Algorithm in and in FIG. 15 a Mockup of “My Contributors Widget” showing Interlinking COMBINED with an Attention Tracking Algorithm. Note that not all Contributors have links because, for privacy reasons, they can choose to remove the link.

### Points as Payments

In the case where Points are $, there is also a payment system in place (at first, thru PayPal only).

This example illuminates one particular implementation but it will be clear that many permutations are possible.

### Contributor Daily Processing:

Once a day (or some other regular or irregular cycle), through the PayPal Subscription System, The ENBVCS processes a $ payment from each Contributor who signed up on that day of the month (e.g. 4^{th} day of the month) [Exceptions are handled in a smooth fashion e.g. not every month has a 29^{th}, 30^{th} or 31^{st} day.]

Note that there may be a few days time lapse in order to give the Contributor the opportunity to cancel or modify their Points allocated.

As explained previously, a particular “attention tracking” algorithm is applied to the tracking data turning the data into Tokens, which are then turned into Points, which in this case are $ allocated to each Recipient Site visited during the last month (with tracking turned ON, and contributing turned ON).

The ENBVCS Payment System then “transfers” the Points (virtually) assigned to each Recipient Site by each Contributor for this day to the Recipient Sites “virtual payment box”.

These Points are added to each Recipient Site's “Contributor Widget Display” and used to update that publicly visible information on a daily basis.

Each Contributor in this daily cycle period of the 4^{th} day of the month also has their “Recipient Widget Display” updated to reflect Points disbursed. [Note that ALL Contributors—not just the ones in the 4^{th} day of the month cycle—could also be provided an update to their “Recipient Widget Display” to show the current activity since the last payout, which is not finalized until the end of the Contributor's monthly payment period.]

Once all the Contributors are processed, the ENBVCS Payment System processes the payouts for the Recipients (by Recipient Site).

### Recipient Site Daily Processing:

Depending on the payout criteria for each Recipient Site (which could be set by the ENBVCS, or the Recipient, or a combination of both), payouts of $ are made to the Payment Service specified for each Recipient Site (e.g. a PayPal Account). Possible criteria are day of month (e.g. 4^{th} day of the month, amount above a threshold e.g. $10, and so on). Assume 4^{th} day of the month for this example.

All Recipients that registered on the 4^{th} of the month (or this could be when the Recipient Site was added by the Recipient) receive the total amount of Points (which are $ here) from their “virtual payment box” and that box is zeroed out for the next payment cycle.

### ENBVCS Payment Process

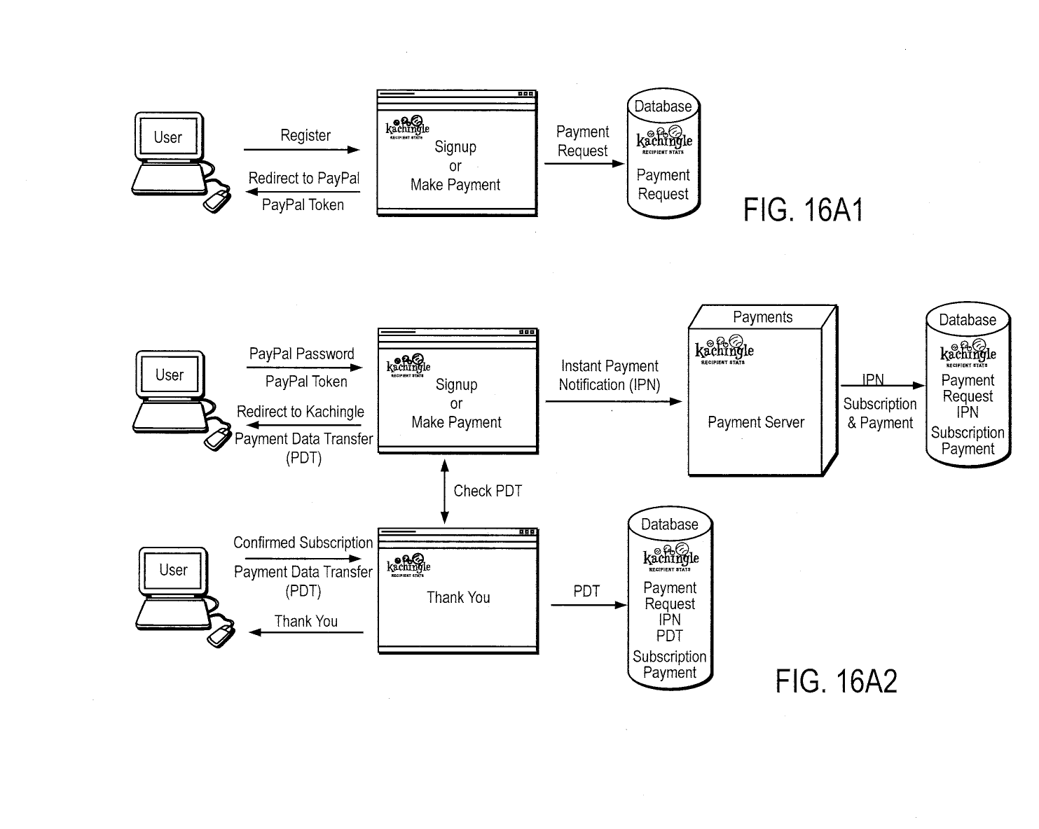

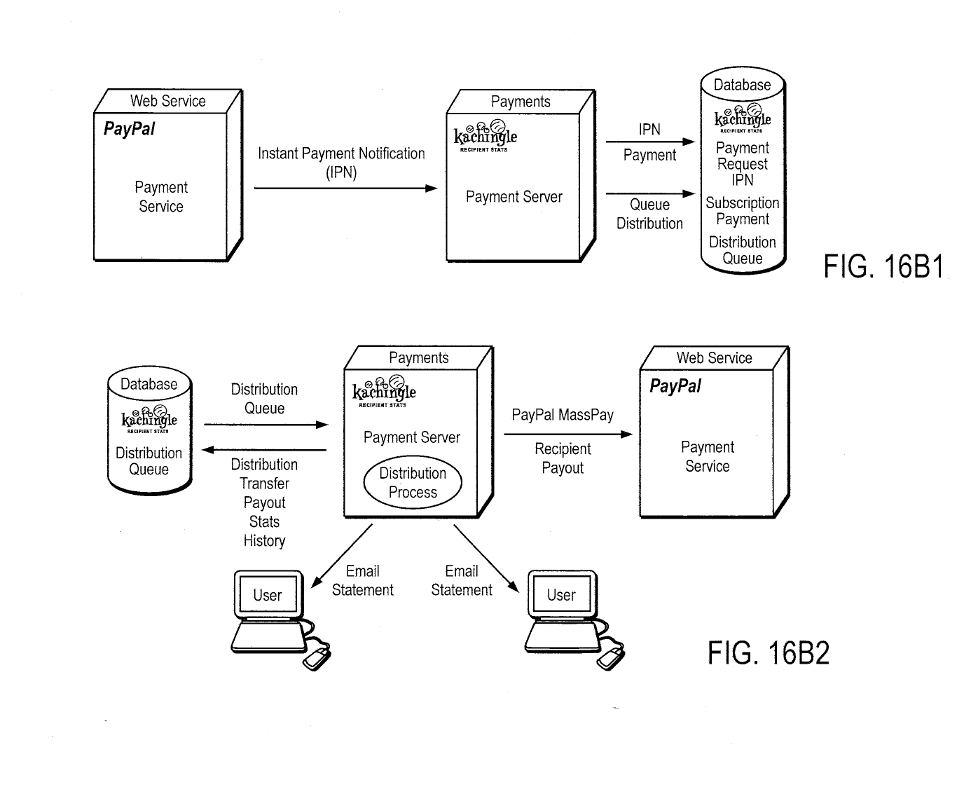

This diagram in FIG. 16 illustrates one possible implementation for the financial transactions linked to the ENBVCS. There are two different flows: the flow to collect the contributions and the flow to redistribute these contributions to the recipients.

Collecting the contributions:
the contributor registers a payment system (which can be handled internally or outsourced to an existing payment system, as PayPal in this illustration)
the contributor agrees either through the ENBVCS site or directly on the payment system site to a regular payment (monthly, quarterly or others), or a one time fee payment for a certain duration
ENBVCS collects contributions using the agreed upon conditions of payment.

The contributor can be notified through email or other notification system before the regular payment goes through. S/he can then be provided with information such as itemized amount paid to recipients, recipients sites visited but excluded from payment, etc. . . . .

The contributor can be offered the possibility to modify his choices of distribution for his/her contribution

Distributing the contributions: at regular time intervals agreed upon, the sum of the individual contributions is computed and the share previously agreed upon is delivered to the recipients, using an external payment system (which can be different from the one used to collect the contributions) or an internal payment system. This could also be done in real-time, by setting a “price” for each Token.

### Payment Proof: Proof of Points Allocation

If Points are turned into $, In order to earn the trust of Contributors and Recipients and prevent fraud by the ENBVCS, a mechanism must be in place to prove without any doubt that the Points as $ have actually been distributed appropriately.

The mechanism for doing this is based on the combination of multiple criteria, including but not limited to:
This proof is preferably cost-free and automated (e.g. no employee overhead),
Proof preferably exists for every Contributor to validate their distributions, at least in certain embodiments,
Even though every Contributor will not necessarily exam this proof if it exists, because it exists for each Contributor it is expected that SOME Contributors will check their data, the ENBVCS PaymentProof System, in embodiments that are transparent to the user, handles and enables proof checking by any random subset of Contributors at any time.

The transparent embodiments of the ENBVCS PaymentProof System ensure that every contribution made to every Recipient Site is visible to all users of the ENBVCS system (and in fact any visitor to the Recipient Site, not just ENBVCS users).

By making exactly the same contributions visible to both the Contributors and Recipients, cross-validation can be performed because the Contributor knows how his/her contributions were supposed to be distributed (by viewing the “My Recipients Widget”), and that amount, spread across the Recipient Sites, must total up to the amount that was contributed for that payout period (e.g. $5/month).

The Recipient Site knows how much money was deposited in their account, and that amount must total up to the amounts from all of the Contributors for their payout period. [Note that there is the impact of transaction fees but this does not invalidate the basic PaymentProof system and will be addressed in the next section.]

Assume that in PaymentProof Stage 1:

No Privacy constraints have been imposed by an of the Contributors and the Contributor name shown is unique. These assumptions will be lifted as we step thru the PaymentProof algorithm

PaymentProof Stage 1: Simplified “My
Contributors Widget” for a Recipient Site

| | Contributors | | | |
|---|---|---|---|---|
| | (includes | | | Date of Actual |
| Contri- | links to “My | | | Payment |
| bution | Recipients | Amount | Date of | Distribution to |
| ID | Widget) | Contributed | Contribution | Recipient Site |
| 1 | Don | $.34 | Date 1 | Date X |
| 2 | Surfing Dude | $.34 | Date 1 | Date X |
| 3 | samtheblackgsd | $6.76 | Date 1 | Date X |
| 4 | Bambi | $5.24 | Date 2 | Date X |
| 5 | Ann Taylor | $1.23 | Date 2 | Date X |
| 6 | Blue Cat | $.46 | Date 3 | Date X |
| | Total for Date X | $14.48 | | |
| | Distribution | | | |
| 7 | Albert Einstein | $ .46 | Date 4 | Date Y |

Each Contributor can visit the “My Contributors Widget” and find his/her $ distribution which must match up to what is shown in his/her “My Recipients Widget”. The Contributor can be assured that the ENBVCS is not serving up a special perhaps modified “My Contributors Widget” to each Contributor because this same information is visible with tracking off, and to ANY visitor to the site.

The Recipient knows exactly how much $ were deposited in his/her payment service account on Date X and can validate that these Contributor amounts equal that payment amount. The Recipient can also check each Contributor's “My Recipients Widget” to verify that the amounts shown are equal.

Both Recipients and Contributors will be given a mechanism to contact The ENBVCS if there is a discrepancy, but more importantly, they have power of “word of mouth” in the blogosphere/internet and will be able to tell their peers that the system is not behaving properly.

Now, lift the assumption that the Contributors have not imposed privacy constraints on their contributions but keep the assumption that the Contributor name is unique.

Assume that in PaymentProof Stage 2:

Privacy constraints have been imposed by some or all of the Contributors and the Contributor name is unique. The privacy constraint that the Contributor can impose is to remove the link to their “My Recipients Widget”; however the Contributor cannot modify the contribution information (name+amount+dates). This means that the Recipient Site cannot verify that the amounts shown in the two interlinked widgets are equal, but every Contributor still can.

Now lift the assumption that the Contributor name is unique because the Contributor can choose to supply his/her unique username, a special name for this Recipient Site only (which may or may not be unique to this Recipient Site in generally), or anonymous (which is clearly not unique). The problem that now must be solved to achieve absolute proof of payment are the cases where:

for a Distribution Date X, there are multiple contribution amounts of the same $ amount,

where two or more of these Contributors have provided the same name (e.g. a special name or anonymous).

In this situation, an individual Contributor cannot absolutely verify his/her Contribution on the “My Contributors Widget” because the ENBVCS could have “skimmed” the duplicate amounts (or modified the amounts to make them the same). [Although this situation would be rare in percentage of transactions, once the ENBVCS achieves millions of transactions a day it will not be insignificant).

PaymentProof Stage 2: Simplified “My Contributors Widget” for a Recipient Site

| | Contributors (some | | | Date of Actual |
|---|---|---|---|---|
| | include links to “My | | | Payment |
| Contribution | Recipients Widget, some | Amount | Date of | Distribution to |
| ID | do not) | Contributed | Contribution | Recipient Site |
| 1 | Anonymous (no link) | $.34 | Date 1 | Date X |
| | [actual user = Don but | | | |
| | this name not visible] | | | |
| 2 | Anonymous (no link) | $.34 | Date 1 | Date X |
| | [actual user = Surfing | | | |
| | Dude but this name not | | | |
| | visible] | | | |
| 3 | samtheblackgsd | $6.76 | Date 1 | Date X |
| 4 | Baby Deer (special name, | $5.24 | Date 2 | Date X |
| | no link) | | | |
| 5 | Ann Taylor | $1.23 | Date 2 | Date X |
| 6 | Blue Cat | $.46 | Date 3 | Date X |
| | Total for Date X | $14.48 | | |
| | Distribution | | | |
| 7 | Albert Einstein | $ .46 | Date 4 | Date Y |

In the PaymentProof Stage 2 Table it can be seen that two Contributors (Don and Surfing Dude) coincidentally made the exact same contribution amount, on the same day, and both chose to be anonymous. So, the situation now arises where these users cannot pinpoint which contribution is actually theirs. This then would allow the ENBVCS to only report ONE contribution amount and skim off the other one.

Assume that in PaymentProof Stage 3:

Privacy constraints have been imposed by some or all of the Contributors. Contributor names may not be unique.

The solution to this is simple but elegant. When a payment is transacted thru a payment system for each Contributor, a third party supplies a unique ENBVCS-independent transaction number. Ideally this transaction number comes from the independent payment service (e.g. PayPal) but it could come from any independent third party. This third party independently reports the transaction number (via some form of communication such as email) to the Contributor (and of course, to the ENBVCS system).

PaymentProof Stage 3: Simplified “My Contributors Widget” for a Recipient Site

| | | | | Date of | |
|---|---|---|---|---|---|
| | | | | Actual | |
| | Contributors (some | | | Payment | |
| | include links to “My | | | Distribution | Third Party |
| Contribution | Recipients Widget, some | Amount | Date of | to Recipient | Transaction |
| ID | do not) | Contributed | Contribution | Site | Code |
| 1 | Anonymous (no link) | $.34 | Date 1 | Date X | 12345 |
| | [actual user = Don but | | | | |
| | this name not visible] | | | | |
| 2 | Anonymous (no link) | $.34 | Date 1 | Date X | 67898 |
| | [actual user = Surfing | | | | |
| | Dude but this name not | | | | |
| | visible] | | | | |
| 3 | samtheblackgsd | $6.76 | Date 1 | Date X | 11223 |
| 4 | Baby Deer (special name, | $5.24 | Date 2 | Date X | 77869 |
| | no link) | | | | |
| 5 | Ann Taylor | $1.23 | Date 2 | Date X | 87906 |
| 6 | Blue Cat | $.46 | Date 3 | Date X | 66758 |
| | Total for Date X | $14.48 | | | |
| | Distribution | | | | |
| 7 | Albert Einstein | $ .46 | Date 4 | Date Y | 77784 |

Now every Contributor, including those who are provided the same name (including anonymous) and amount on the same day to the same Recipient Site, can be assured that their payment was properly distributed.

### PaymentProof: Addressing the Impact of Transaction Fees

Transaction fees impact the PAYMENTPROOF algorithm in a way that is easily solved.

There are 3 transaction fees:
ENBVCS payment service transaction fee [taking the $ from the Contributor] (Fee-C)
ENBVCS transaction fee (Fee-K)
Recipient (Site) transaction fee (Fee-R)

The fees are dependent on the client—C, K, and R. Only K is under the control of ENBVCS.
Basic Facts:
The Contributor knows only Fee-K
ENBVCS knows only Fee-C and Fee-K
Recipient knows only Fee-R and Fee-K
Fee-R is private and cannot be generally revealed

Note that fee-K can be a variable dependent on any number of parameters such as amount of total contributions by this Contributor, type of Recipient Site (e.g. non-profit vs. for-profit), currency type and so on. Because both Fee-C and Fee-K are part of the Contributor doing business with the ENBVCS, they can be lumped together as Fee-CK. It is this overall fee that must be revealed.

PaymentProof Transaction Fees: Sample Table 1 of Points as $

| Points for each | From | From | From | From | From |
|---|---|---|---|---|---|
| Recipient Site | Contributor A | Contributor B | Contributor C | Contributor D | Contributor E |
| 1—$115.21 total | $5 | $11.29 | | | $99.01 |
| 2—$19.01 total | | $8.71 | $9.99 | $.31 | |
| 3—$13.73 total | $2.50 | | $10.01 | $1.21 | $.01 |
| 4—$31.98 total | | | $20 | $11 | $.98 |
| 5—$12.50 total | $2.50 | | $10 | | |

Each contribution amount is modified by the three transaction fees e.g. the $5 provided by Contributor A to Recipient Site 1 actually turns into:

Delivered to Recipient 1 payment service: ($5−Fee-CK−Fee-R). The amount displayed on the public version of “My Recipients Widgets” and “My Contributors Widgets” continues to be the full amount, but the ENBVCS also adds a column with the amount minus Fee-CK. Assume 12% for this example.

PaymentProof Transaction Fees: Sample Table 2 of Points as $

| Points for each | From | From | From | From | From |
|---|---|---|---|---|---|
| Recipient Site | Contributor A | Contributor B | Contributor C | Contributor D | Contributor E |
| 1—$115.30 total without | $5 | $11.29 | | | $99.01 |
| transaction fees | | | | | |
| 1—$101.46 total minus | $4.40 | $9.94 | | | $87.13 |
| Fee-CK | | | | | |

The ENBVCS published to the Contributor the Fee-CK. The Contributor can then verify that this is the amount being reported to the Recipient Site because it is public information on the “My Contributors Widget”.

The Recipient knows exactly how much money has been deposited into his/her payment service account (for each Recipient Site) and can now verify that the amount is the “total minus the Fee-CK”. The Recipient payment service also takes a transaction fee Fee-R, but the Recipient is aware of this fee (and it can be different for each Recipient Site payment service account).

### Finding “Contributors Similar to Me (or Similar to Another Contributor(s))”

The ENBVCS can use the data in the “My Contributors Widget” and “My Recipients Widget” to enable users and visitors (subject to privacy constraints) to find similar (or dramatically different) types of Contributors.

It's clear from the data shown in the two widgets that database queries can be made to do logical operations such as:
Given a particular Contributor's Recipient Sites, find other Contributors who are also contributing to these sites
Given a particular Contributor's Recipient Sites, find other Contributors who are also contributing to 50% of these sites
Given a set of Recipient Sites, find all of the Contributors who are contributing to these sites
And so on . . . .

The answers to these queries, when delivered to the Contributor, enable them to find people in a whole new way—which is based on their contributing behavior.

Finding New Recipient Sites that are Similar to the Ones I (or Other Specific Contributors(s)) Like

The ENBVCS can use the data in the “My Contributors Widget” and “My Recipients Widget” to enable users and visitors (subject to privacy constraints) to find similar (or dramatically different) types of Recipient Sites.

It's clear from the data shown in the two widgets that database queries can be made to do logical operations such as:
Given a particular Recipient Site's Contributors, find the other Recipient Sites they are contributing to
Given a particular Recipient Site's Contributors, find the other Recipient Sites that 50% of them have in common
And so on . . . .

The answers to these queries, when delivered to the user, enable them to find Recipient Sites in a whole new way—which is based on their Contributors' contributing behavior.

### Badges

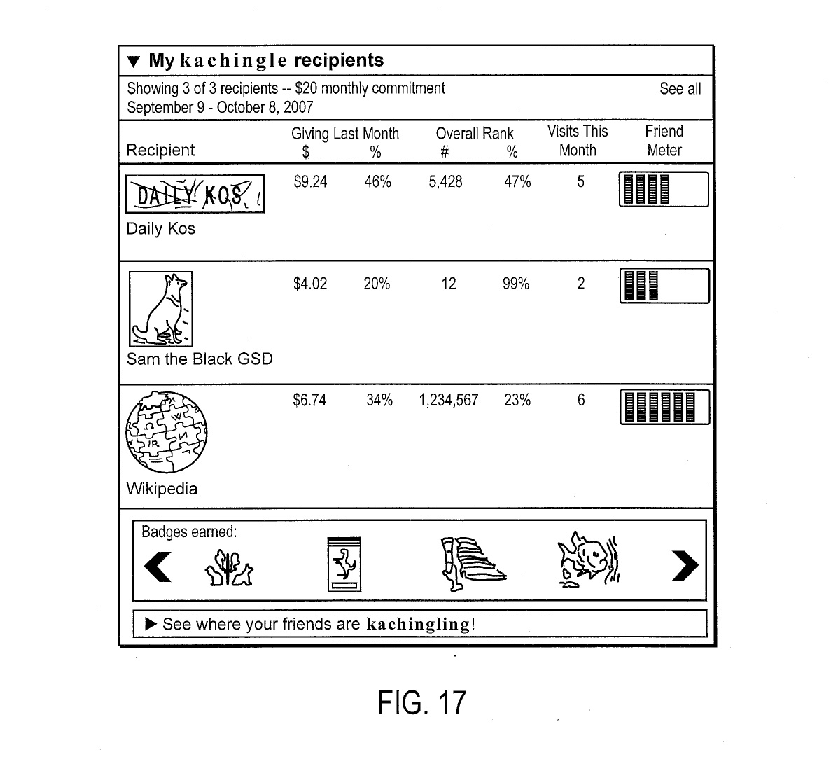

BADGES: As shown in FIG. 17, the ability and mechanism for any user to create aggregations consisting of the following parameters:

specific (or a category of) “Recipient Sites”

Tokens or Points provided to these sites by a particular Contributor

. . . and any other criteria such as time frame in which these Tokens/Points were accrued and then define a Badge to this aggregation. The ENBVCS will then automatically award/offer this Badge to any Contributor whose activity is equal to or greater than the Badge requirements.

A user can select any set of Recipient Sites and give this aggregation a name, a logo (badge), and a set of criteria that a Contributor much achieve in order to be offered the badge.

User A creates an aggregation of Recipient Sites
and calls it “German Shepherd Rescue”

| | Recipient Site | | | |
|---|---|---|---|---|
| | | | | Ban |
| | | German | | German |
| Sample | | Shepherd | Save German | Shepherd |
| Criteria | | Rescue | Shepherds | puppy |
| Required | Samtheblackgsd | N. CA | in MO | mills |
| Points | >10 | >3 | 1 | >5 |
| Timeframe | 3 mo | 1 mo | 1 yr | any |

Other processing can be placed on top of the above set, e.g. 75% of the requirements must be met.

When the ENBVCS performs the regular processing for Contributors, after completing the calculations for each Contributor, it then compares that Contributor's Recipient Sites, Points allocated and timeframes (and any other criteria set by the Badge creator and/or the ENBVCS) to determine if the criteria for any Badges have been attained. If yes, the ENBVCS queues up these Badges for the Contributor to decide if s/he would like to be awarded them, and potentially display them on his/her public “My Recipient Sites” widget.

### Multiple Levels

While one embodiment of the ENBVCS enables a single level of contribution—e.g. the Points go to a particular Recipient Site, it is clear that multiple levels can also easily be implemented in other embodiments. For instance, imagine Recipient Site 1 that has embedded content created by other Recipients, say Recipient Site 2. Recipient Site 2, which is embedded in Recipient Site 1, also has a form of the ENBVCS Medallion. So when Recipient Site 1 is visited by a Contributor, both Medallions communicate with the ENBVCS Server and are tracked. The ENBVCS can now appropriately distributed users' contributions to all of the Recipient Sites that make up that accessed content. This mechanism would enable “fair” allocation of contributions to all kinds of content that is often embedded in other content—such as video, audio, images, etc.

Another similar but slightly different mechanism is to distribute the contributions to a single Recipient, but keep track of which areas of that Recipient Site have been tracked. For instance, the NYTimes could implement a separate Recipient Site Medallion for each columnist, and then monetarily reward the columnists based on the Points they receive. Or, the ENBVCS itself could create this financial distribution system and directly do the split, based on the business arrangement between the columnist and the organization.

### Architecture Overview

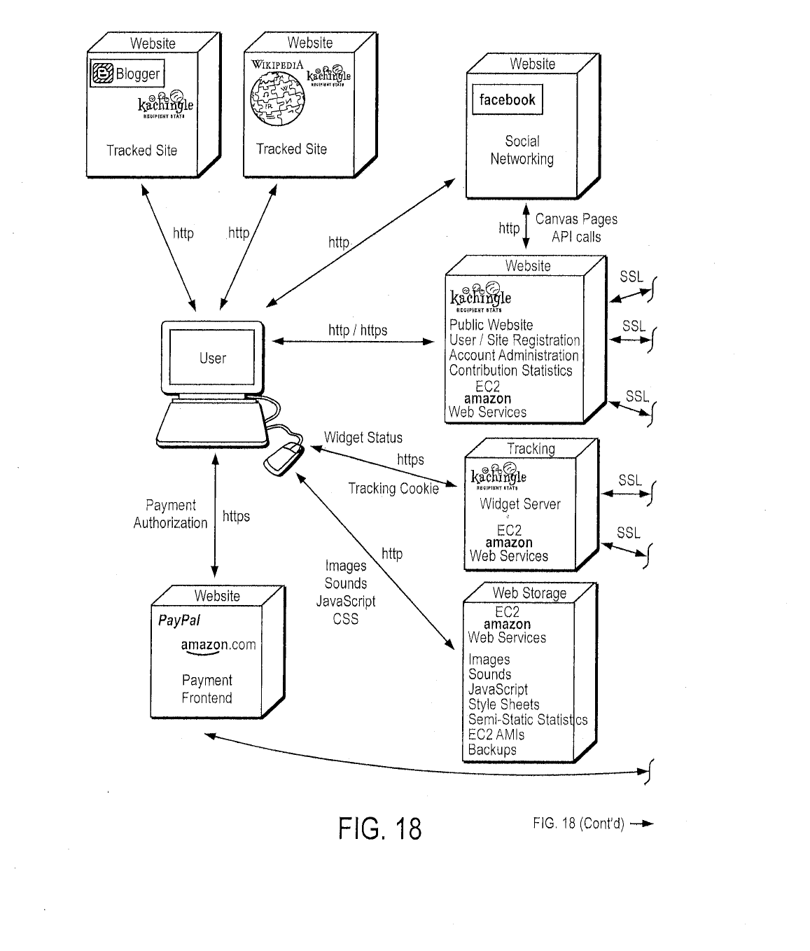

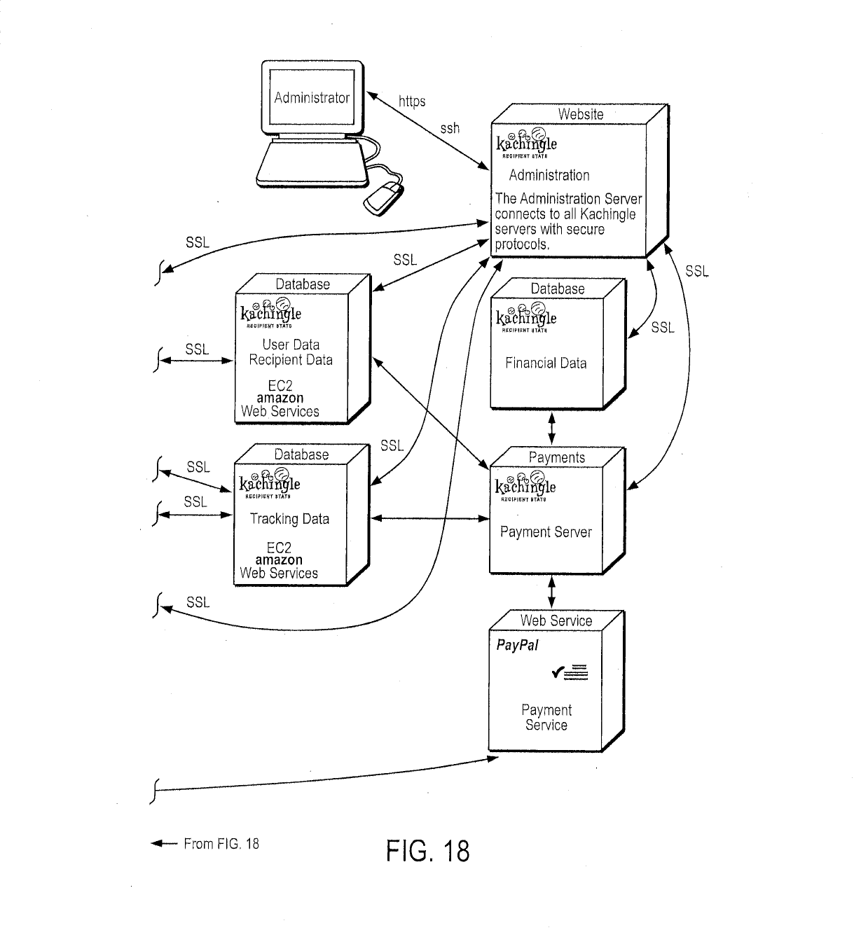

One functional implementation can be itemized in several components, as shown in FIG. 18:
a mechanism to track visits placed on the recipients Web sites. This system can be distributed between the recipients site and other sites (The ENBVCS being a possibility)
a registration system hosted on the ENBVCS web site or any other location to gather contributors registrations, help contributors administrate their accounts and check data regarding their visits or data regarding other subscribers visits
a payment system (previously described)
a set of applications placed on other Web sites (social networking sites and any others) to share information about visits habits
a set of administration servers used to maintain data integrity, manage the tracking data, help consult data (through data mining applications or others)

### Adplacement

The ENBVCS is a system for revealing what online content and services consumers value. This knowledge (and the underlying system) could be used to create a myriad of lines of businesses.

Because the ENBVCS system knows what content and services people contribute to, which means that those content and services are highly valued, that knowledge could be used to help advertisers decide where (and what) to advertise online.

One example is the use of marketing rewards to fill users' accounts in exchange for them revealing their contributing behavior.

### Monthly ENBVCS “Pass” is a Reward Choice for Customer Rewards Programs

MyCokeRewards is an example. Coke is trying to connect with their consumers on the internet since they don't deal with them directly in any other way. The way it works now is a consumer signs up for mycokerewards and then enters codes they find on the bottles (that they drank). After a certain number of points have been accumulated, the consumer can choose an award—a rental car upgrade, a free ringtone, a remote, etc. Now, assume a reward is a one (two, three?) month “subscription” to the ENBVCS. Coke then gives the ENBVCS the money, which is then placed in that specific customer's ENBVCS account. But that's not the end, it's really the beginning. Because the ENBVCS then reveals to Coke, on the aggregate* where their customers choose to allocate their ENBVCS dollars. Coke now has very specific information about where to advertise and what their sites their customers not only visit, but highly value and want to be part of their personal online persona.

(* tracking can also be by individual, if the required permissions from the consumer are obtained)

### Search Improvement

There are many other ways the underlying data could be integrated and sold, most likely in aggregate, to another company.

For example, a search engine (e.g. Google) or people engine (Match.com) could use ENBVCS data as part of the information used to determine the “best” search for content or people results for a query.

For example, if a user is searching for “wind surfing”, the regular search algorithm could be enhanced by including the ENBVCS ranking for those sites—the ones that have a higher number of ENBVCS points (or contributions) have been identified thru the ENBVCS, by users, to be more valuable than others.

For example, if a user on a matchmaking site is searching for “someone with certain characteristics” input from the ENBVCS could help make the results better and more realistic, since the ENBVCS is about what you do and value (online) rather than what you say you do. That is, if a client says “I like dogs” but all they contribute to are cat blogs, that is less compelling than a person who says “I like dogs” AND who also contributes to dog blogs.

### Tagging

Recipient Site and Contributors can tag, and the tags can be more meaningful for a site depending on the value provided by a contributor.

For example, if Contributor A provides $10 to Recipient Site X and tags it as “dog” That tag becomes more part of the identity of Recipient Site X than Contributor B providing only $1 and tagging it as “cat”.

Now suppose that some Contributors to Recipient Site X tagged it as “dog” and their contributions add up to 100 Points (or $100). And imagine Recipient Site Y that has less total Points (or $)—say 50 Points (or $50) from Contributors that tagged that site with “dog”. Recipient Site X would then show up higher above Recipient Site Y in a user search for all or some of the Recipient Sites with the tag of “dog”.

### Searching

Because we allocate points which can be turned into $, our search mechanism adds a new type of metric to finding stuff on the internet based on how much people are willing to spend to support the Recipient Site. Compared to other available algorithms which set the importance of a webpage by the number of links pointing to it (and the reputation of these links which is defined by the same algorithm), the present system values a Recipient site (which is one or more webpages combined) based on how much actual money readers/users/contributors have PAID to support that site. This embodiment ultimately will provide a more powerful search algorithm than conventional page ranking.

There is also an mirror implication, which is that advertisers on a Recipient Site can evaluate how much they are willing to spend on advertising on that site based on how much money contributors are providing to that site, and other information such as the total amount that those contributors are providing across all sites, or across all sites of a certain category, etc.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed is:

1. A method of establishing support for various internet locations using a computer system comprising the steps of:
identifying each of a plurality of supported recipient sites at the computer system by receipt of an electronic support request at the computer system, each received electronic support request corresponding to a particular internet location that is thereby included as one of the plurality of supported recipient sites;
identifying each of a plurality of contributors at the computer system by receipt of an electronic contributor request, each of the plurality of electronic contributor requests corresponding to one of the plurality of contributors that can personally rate at least some of the supported recipient sites, wherein each of the plurality of contributors is uniquely identifiable by the computer system, and wherein, associated with each of the plurality of contributors is a contribution amount that is divisible into a plurality of contribution units, each contribution unit corresponding to one of the plurality of contributors positively rating one of the supported recipient sites by providing a contribution request at the one supported recipient site
tracking, for at least some of the plurality of supported recipient sites, receipt of each contribution request at the computer system; and
processing the plurality of contributions requests using the computer system, the processing including determining a compensation amount to distribute to the at least some of the supported recipient sites based upon at least some of the contribution requests using a compensation algorithm.

2. The method according to claim 1 further including transmitting a plurality of compensation amount orders to a payment entity for each of the some of the supported recipient sites.

3. The method according to claim 1 further including the step of providing display data for one of the contributors, the display data including a list of supported recipient sites to which the one contributor has contributed.

4. The method according to claim 3 wherein the display data is adapted for display on a website associated with the computer system.

5. The method according to claim 3 wherein the display data is adapted for display within a widget that is associated with a website determined by the one contributor that is different from a website associated with the computer system.

6. The method according to claim 1 further including the step of providing display data for one of the supported recipient sites, the display data including a total contribution based upon adding all different contribution requests for that one supported recipient site.

7. The method according to claim 8 wherein the display data is adapted for display on a website associated with the computer system.

8. The method according to claim 7 wherein the display data is adapted for display within a widget that is associated with the one supported recipient site.

9. The method according to claim 1 further including the step of providing display data, the display data including a listing of top supported recipient sites that have received the most contribution requests.

10. The method according to claim 1 further including the step of providing display data, the display data including a listing of contributors that have provided the most contribution requests.

11. The method according to claim 1 further including the step of determining which of the plurality of contributors meet predetermined criteria and identifying badge contributors associated therewith; and
for those badge contributors, providing contributor badge data that allows display of a contributor badge widget associated with that badge contributor.

12. The method according to claim 1 further including the step of determining which of the plurality of supported recipient sites meet predetermined criteria and identifying badge supported recipient sites associated therewith; and
for those badge supported recipient sites, providing recipient badge data that allows display of a recipient badge widget associated with that badge supported recipient site.

13. A method of providing relevant internet locations using a computer system comprising the steps of:
identifying each of a plurality of supported recipient sites at the computer system by receipt of an electronic support request at the computer system, each received electronic support request corresponding to a particular internet location that is thereby included as one of the plurality of supported recipient sites;
identifying each of a plurality of contributors at the computer system by receipt of an electronic contributor request, each of the plurality of electronic contributor requests corresponding to one of the plurality of contributors that can personally rate at least some of the supported recipient sites, wherein each of the plurality of contributors is uniquely identifiable by the computer system, and wherein, associated with each of the plurality of contributors is a plurality of contribution units, each contribution unit corresponding to one of the plurality of contributors positively rating one of the supported recipient sites by providing a contribution request at the one supported recipient site
tracking, for at least some of the plurality of supported recipient sites, receipt of each contribution request at the computer system and the corresponding one of the plurality of contributors that made the contribution request, thereby obtaining, for each of some particular contributors, a listing of that particular contributors supported recipient sites; and
providing for traversal of at certain ones of the some of the plurality of supported recipient sites via the listing of at least one particular contributor, such that a user who goes to one of the supported recipient sites of the at least one particular contributor can traverse the listing of the at least one particular contributor to obtain another supported recipient site.

14. A method of providing identification of other relevant contributors to one user using a computer system comprising the steps of:
identifying each of a plurality of supported recipient sites at the computer system by receipt of an electronic support request at the computer system, each received electronic support request corresponding to a particular internet location that is thereby included as one of the plurality of supported recipient sites;
identifying each of a plurality of contributors at the computer system by receipt of an electronic contributor request, each of the plurality of electronic contributor requests corresponding to one of the plurality of contributors that can personally rate at least some of the supported recipient sites, wherein each of the plurality of contributors is uniquely identifiable by the computer system, and wherein, associated with each of the plurality of contributors is a plurality of contribution units, each contribution unit corresponding to one of the plurality of contributors positively rating one of the supported recipient sites by providing a contribution request at the one supported recipient site
tracking, for at least some of the plurality of supported recipient sites, receipt of each contribution request at the computer system and the corresponding one of the plurality of contributors that made the contribution request, thereby obtaining, for each of some particular contributors, a listing of that particular contributors supported recipient sites; and
processing the listing to determine relationships therein, the processing thereby providing the user who goes to at least some of the supported recipient sites that overlap with certain ones of the some particular contributors, an identification of the certain ones of the some particular contributors.
